(19) United States
(12) Patent Application Publication
(10) Pub. No.: US 2012/0044223 A1
(43) Pub. Date: Feb. 23, 2012

(54) INPUT-OUTPUT DEVICE AND DRIVING METHOD OF INPUT-OUTPUT DEVICE

(75) Inventor: Hikaru TAMURA, Zama (JP)

(73) Assignee: SEMICONDUCTOR ENERGY LABORATORY CO., LTD., Atsugi (JP)

(21) Appl. No.: 13/205,670

(22) Filed: Aug. 9, 2011

(30) Foreign Application Priority Data
Aug. 19, 2010 (JP) 2010-183759

(51) Int. Cl. G09G 5/00

(52) U.S. Cl. 345/207

(57) ABSTRACT

It is an object to increase applications. The present invention shows a driving method of an input-output device which provided with an input-output portion including a pixel portion, and a data processing portion including an image processing circuit, a memory circuit storing a plurality of programs, and a CPU. The pixel portion includes display circuits and photodetector circuits. To the display circuits, a display selection signal is input and a display data signal is input in accordance with the display selection signal. The display circuits become a display state in accordance with a datum of the display data signal which is input. The photodetector circuits generate an optical datum corresponding to an illuminance of incident light. In the method, optical data are stored in the memory circuit, the optical data are read as an image datum from the memory circuit by the image processing circuit sequentially, a label is imprinted on an optical datum with a value larger than a value of a reference datum, optical data on each of which the label of the same group is imprinted is counted, and the process performed by a CPU is changed in accordance with the result of count.

### BACKGROUND OF THE INVENTION

1. Field of the Invention

One embodiment of the present invention relates to an input-output device.

2. Description of the Related Art

In recent years, devices having a function of outputting a datum and a function of inputting a datum with incident light (such devices are also referred to as input-output devices) have been developed

As an input-output device, an input-output device which includes a plurality of display circuits and a plurality of photodetector circuits (also referred to as optical sensors) provided in a matrix in a pixel portion and has a function of detecting coordinates of an object to be read which overlap with the pixel portion (also referred to as a coordinate detecting function) by detecting the illuminance of light incident on the optical sensors and a function of generating image datum of an object to be read (the reading function) can be given (e.g., Patent Document 1). For example, with the coordinate detecting function, the input-output device can have a function as a touch screen. Further, with the reading function, the input-output device can have a function as a scanner. In addition, with the reading function, the pixel portion of the input-output device can display an image based on an image datum generated by the reading function.

### Reference

[Patent Document 1] Japanese Published Patent Application No. 2010-109467

### SUMMARY OF THE INVENTION

Conventional input-output devices cannot be used for many applications.

For example, with a coordinate detecting function, the conventional input-output device can detect not only the coordinates of part of a finger or the like overlapping with a pixel portion but also the coordinates of an object to be read which is larger than a finger and overlaps with the pixel portion. However, the small number of applications utilizes the coordinate detecting function.

In one embodiment of the present invention, it is an object to increase applications capable of utilizing input-output devices.

According to one embodiment of the present invention, a process to be performed is changed in accordance with an area of the region of the pixel portion with which an object to be read overlaps. Therefore, new applications are proposed and applications capable of utilizing an input-output device can be used are increased.

For example, an image processing circuit is used to imprint a label on an optical datum which have a value larger than a value of a reference datum, and the number of optical data on each of which a label of the same group is imprinted is counted, whereby an area of the region of the pixel portion with which an object to be read overlaps is calculated.

In addition, the number of optical data which is counted by the image processing circuit is compared to a reference value, and the process performed by a CPU is changed in accordance with the result of comparison.

According to an embodiment of the present invention, an input-output device includes an input-output portion including a pixel portion, and a data processing portion. The pixel portion includes a plurality of display circuits to which a display selection signal is input, to which a display data signal is input in accordance with the display selection signal, and which become a display state in accordance with a datum of an input display data signal, and a plurality of photodetector circuits which generate an optical datum corresponding to an illuminance of incident light. The data processing portion includes an image processing circuit, a memory circuit in which the plurality of optical data are sequentially stored and a plurality of programs are stored, and a CPU which controls whether one or more of the plurality of programs is performed in accordance with a result of the comparator. The image processing circuit includes a labeling processing circuit in which a label is imprinted on an optical datum with a value larger than a reference datum, a count circuit which counts the number of optical data on each of which a label of the same group is imprinted, and a comparator which compares a count value of the optical data on each of which the label of the same group is imprinted and both a first reference count value and a second reference count value.

An embodiment of the present invention is a driving method of an input-output device. The input-output device includes an input-output portion which includes a pixel portion; and a data processing portion including an image processing circuit, a memory circuit in which a plurality of programs are stored, and a CPU. The pixel portion includes a plurality of display circuits and a plurality of photodetector circuits. To the plurality of display circuits, a display selection signal is input, and a display data signal is input in accordance with the display selection signal. The plurality of display circuits become a display state in accordance with a datum of an input display data signal. The plurality of photodetector circuits generate an optical datum corresponding to an illuminance of incident light. In the driving method of the input-output device, a plurality of optical data is stored sequentially in the memory circuit, the plurality of optical data is read sequentially from the memory circuit by the image processing circuit, a label is imprinted on an optical datum with a value larger than a reference datum, and optical data on each of which the label of the same group is imprinted is counted. In the case of a count value of the optical datum on each of which the label of the same group is imprinted is larger than or equal to a first reference count value and smaller than or equal to a second reference count value, the coordinate of a center of a region in the pixel portion, provided with the photodetector circuit in which the optical datum on which a label of the same group is imprinted is generated, are calculated by the image processing circuit; a datum of the coordinate of the center is output to the CPU; and one or more of the plurality of programs are read from memory circuit and are performed by the CPU in accordance with the datum of the coordinate of the center. In the case of a count value of the optical data on each of which the label of the same group is imprinted is larger than the second reference count value, in the coordinate of a center of a region in the pixel portion, provided with the photodetector circuit in which the optical datum on which a label of the same group is imprinted is generated, one or more of the plurality of programs are read from memory circuit and are performed by the CPU.

According to one embodiment of the present invention, a process can be changed in accordance with the area of the region of the pixel portion with which an object to be read overlaps; therefore, applications capable of utilizing an input-output device can be used can be increased by using the above function.

### BRIEF DESCRIPTION OF THE DRAWINGS

FIGS. 1A and 1B illustrate an example of an input-output device in Embodiment 1.

FIGS. 2A to 2C-3 illustrate examples of a function of an input-output device in Embodiment 2.

FIGS. 3A to 3C-2 illustrate examples of a function of an input-output device in Embodiment 3.

FIGS. 4A to 4F illustrate photodetector circuits in Embodiment 4.

FIGS. 5A to 5D illustrate display circuits in Embodiment 5.

FIGS. 6A to 6E are schematic cross-sectional views each illustrating a structural example of a transistor according to Embodiment 6.

FIGS. 7A to 7E are schematic cross-sectional views illustrating an example of a process for manufacturing the transistor illustrated in FIG. 6A.

FIGS. 8A to 8D are schematic views each illustrating an example of an electronic device according to Embodiment 7.

### DETAILED DESCRIPTION OF THE INVENTION

Examples of embodiments of the present invention will be described with reference to the drawings below. Note that the present invention is not limited to the following description because it will be easily understood by those skilled in the art that various changes and modifications can be made without departing from the spirit and scope of the present invention. Thus, the present invention should not be interpreted as being limited to the description of the embodiments.

Note that the contents in different embodiments can be combined with one another as appropriate. In addition, the contents in different embodiments can be interchanged one another.

### Embodiment 1

In this embodiment, an example of an input-output device that can output datum by displaying an image and can input a datum by using incident light (also referred to as an input-output system) is described.

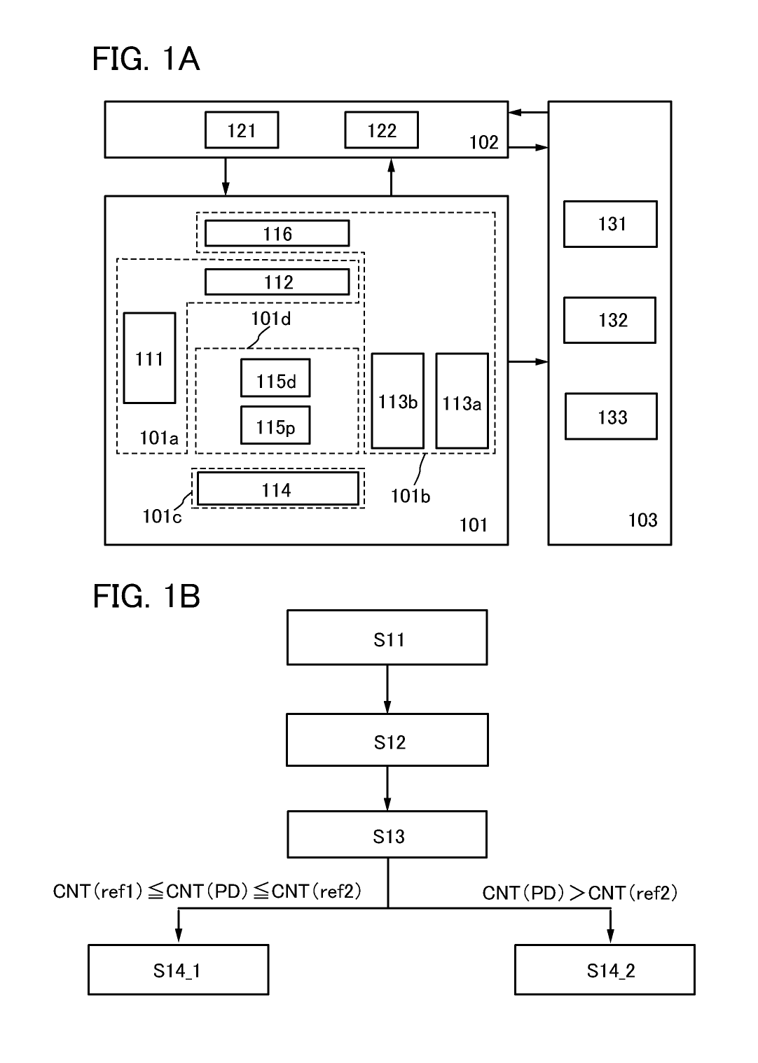

An example of an input-output device in this embodiment will be described with reference to FIGS. 1A and 1B. FIGS. 1A and 1B are diagrams for explaining an example of the input-output device in this embodiment.

First, a structural example of the input-output device in this embodiment will be described with reference to FIG. 1A. FIG. 1A is a schematic diagram illustrating the structural example of the input-output device in this embodiment.

An input-output device in FIG. 1A includes an input-output portion (also referred to as I/O) 101, an input-output control portion (also referred to as I/OCTL) 102, and a data processing portion (also referred to as DataP) 103.

The input-output portion 101 performs input-output of a datum.

The input-output control portion 102 controls input operation and output operation of the input-output portion 101. For example, input operation means the operation of generating a datum in accordance with the illuminance of incident light, and output operation means operation of displaying an image. Note that the input-output control portion 102 does not have to be provided. Operation of the input-output portion 101 may be controlled from the outside.

The data processing portion 103 performs a process in accordance with an input data signal. Further, the data processing portion 103 have a function of performing a program selected in accordance with a datum of an input data signal, as necessary. For example, in accordance with a datum input from the input-output portion 101, the data processing portion 103 detects the coordinates of an object to be read, calculates an area of an object to be read, compares the value of the calculated area and a reference value, performs a process based on the result of the comparison, or generates an image datum.

Further, the input-output portion 101, the input-output control portion 102, and the data processing portion 103 are described below.

The input-output portion 101 includes a display selection signal output circuit (also referred to as DSELOUT) 111, a display data signal output circuit (also referred to as DDOUT) 112, a photodetection reset signal output circuit (also referred to as PRSTOUT) 113a, an output selection signal output circuit (also referred to as OSELOUT) 113b, a light unit (also referred to as LIGHT) 114, a plurality of display circuits (also referred to as DISP) 115d, a plurality of photodetector circuits (also referred to as PS) 115p, and a reading circuit (also referred to as READ) 116.

The display selection signal output circuit 111 and the display data signal output circuit 112 are provided in a display circuit driver portion 101a. The display circuit driver portion 101a controls driving of the display circuit 115d.

Further, the photodetection reset signal output circuit 113a, the output selection signal output circuit 113b, and the reading circuit 116 are provided in a photodetector circuit driver portion 101b. The photodetector circuit driver portion 101b controls driving of the photodetector circuit 115p.

The light unit 114 is provided in a light source portion 101c. The light source portion 101c emits light.

The display circuits 115d and the photodetector circuits 115p are provided in a pixel portion 101d. The pixel portion 101d displays an image. In addition, light to be a datum enters the pixel portion 101d. Note that one or more display circuits 115d forms one pixel. Further, a pixel may include one or more photodetector circuits 115p. Moreover, a plurality of display circuits 115d may be arranged in a matrix in the pixel portion 101d. Further, a plurality of photodetector circuits 115p may be arranged in a matrix in the pixel portion 101d.

The display selection signal output circuit 111 has a function of outputting a plurality of display selection signals that are pulse signals (signals DSEL).

The display selection signal output circuit 111 includes a shift register, for example. The display selection signal output circuit 111 can output display selection signals by outputting pulse signals from the shift register.

An image signal that is an electrical signal representing an image is input to the display data signal output circuit 112. The display data signal output circuit 112 has a function of generating a display data signal (a signal DD) that is a voltage signal on the basis of the input image signal and outputting the generated display data signal.

The display data signal output circuit 112 includes a switching transistor, for example.

Note that in the input-output device, the transistor includes two terminals and a current control terminal for controlling current caused to flow between the two terminals by applied voltage. Note that without limitation to the transistor, in an element, terminals between which current flows and the current is controlled are also referred to as current terminals. Two current terminals are also referred to as a first current terminal and a second current terminal.

Further, in the input-output device, a field-effect transistor can be used as the transistor, for example. In a field-effect transistor, a first current terminal, a second current terminal, and a current control terminal are one of a source and a drain, the other of the source and the drain, and a gate, respectively.

The term “voltage” generally means a difference between potentials at two points (a potential difference). However, voltage and potential may be both represented by volts (V) in a circuit diagram or the like; thus, it is difficult to distinguish them. For this reason, in this specification, a potential difference between a potential at one point and a potential to be a reference (a reference potential) is used as voltage at the point in some cases unless otherwise specified.

The display data signal output circuit 112 can output a datum of an image signal as a display data signal when the switching transistor is on. The switching transistor can be controlled by inputting a control signal that is a pulse signal to the current control terminal. Note that in the case where the number of display circuits 115d is more than one, a plurality of switching transistors may be selectively turned on or off so that data of image signals is output as a plurality of display data signals.

The photodetection reset signal output circuit 113a has a function of outputting photodetection reset signals that are pulse signals (signals PRST).

The photodetection reset signal output circuit 113a includes a shift register, for example. The photodetection reset signal output circuit 113a can output photodetection reset signals by output of pulse signals from the shift register.

The output selection signal output circuit 113b has a function of outputting output selection signals that are pulse signals (signals OSEL).

The output selection signal output circuit 113b includes, for example, a shift register. The output selection signal output circuit 113b can output output selection signals by outputting pulse signals from the shift register.

The light unit 114 is a light unit including a light-emitting diode as a light source.

The light-emitting diode emits light of wavelengths in the visible region (e.g., wavelengths in the range of 360 to 830 nm). As the light-emitting diode, a white light-emitting diode can be used, for example. Note that the number of light-emitting diodes of different colors may be more than one. A red light-emitting diode, a green light-emitting diode, and a blue light-emitting diode can be used as the light-emitting diode. When a red light-emitting diode, a green light-emitting diode, and a blue light-emitting diode are used, a driving method (also referred to as a field sequential driving method) in which a color image is displayed and color detection of an object to be detected can be performed by, for example, sequentially making one or more of the red light-emitting diode, the green light-emitting diode, and the blue light-emitting diode emit light in one frame period in accordance with the display selection signal.

It is also acceptable that a control circuit that controls light emission of the light-emitting diodes is provided and the light-emitting diodes are controlled in accordance with a control signal that is a pulse signal input to the control circuit.

The display circuit 115d overlaps with the light unit 114. Light enters the display circuit 115d from the light unit 114. To the display circuit 115d, a display selection signal that is a pulse signal is input, and a display data signal is input in accordance with the input display selection signal. The display circuit 115d changes its display state in accordance with a datum of the input display data signal.

The display circuit 115d includes a display selection transistor and a display element, for example.

The display selection transistor has a function of selecting whether a datum of a display data signal is input to the display element.

The display element changes its display state when the datum of the display data signal is input to the display element in response to the behavior of the display selection transistor.

As the display element, a liquid crystal element or the like can be used, for example.

As a display mode of the input-output device including a liquid crystal element, a TN (twisted nematic) mode, an IPS (in-plane-switching) mode, an STN (super twisted nematic) mode, a VA (vertical alignment) mode, an ASM (axially symmetric aligned micro-cell) mode, an OCB (optically compensated birefringence) mode, an FLC (ferroelectric liquid crystal) mode, an AFLC (antiferroelectric liquid crystal) mode, an MVA (multi-domain vertical alignment) mode, a PVA (patterned vertical alignment) mode, an ASV (advanced super view) mode, an FFS (fringe field switching) mode, or the like may be used.

The photodetector circuit 115p overlaps with the light unit 114. Light enters the photodetector circuit 115p from the light unit 114. A photodetection reset signal and an output selection signal are input to the photodetector circuit 115p. Further, photodetector circuits 115p for detecting red light, green light, and blue light can also be provided. For example, red, green, and blue color filters are provided, and color image datum can be generated by generating an optical datum with the photodetector circuits 115p for detecting light of these colors with the use of the red, green, and blue color filters and by generating an image datum by combining a plurality of pieces of generated optical datum.

The photodetector circuit 115p is in a reset state in accordance with a photodetection reset signal.

In addition, the photodetector circuit 115p has a function of generating datum that is a voltage based on the illuminance of incident light (such a datum is referred to as an optical datum or PDATA) in accordance with a photodetection control signal.

Further, the photodetector circuit 115p has a function of outputting the generated optical datum as an optical data signal in accordance with an output selection signal.

The photodetector circuit 115p includes, for example, a photoelectric transducer (PCE), an amplifier transistor, and an output selection transistor.

The photoelectric transducer is supplied with current (also referred to as photocurrent) by incidence of light on the photoelectric transducer in accordance with the illuminance of incident light.

An output selection signal is input to a current control terminal of the output selection transistor. The output selection transistor has a function of selecting whether an optical datum is output as an optical data signal from the photodetector circuit 115p.

Note that the photodetector circuit 115p outputs an optical datum as an optical data signal from a first current terminal or a second current terminal of the amplifier transistor.

The reading circuit 116 has a function of selecting the photodetector circuit 115p used to read an optical datum and reading the optical datum from the selected photodetector circuit 115p.

For example, a selection circuit is used for the reading circuit 116. The selection circuit includes a switching transistor and an optical datum can be read by input of an optical data signal from the photodetector circuit 115p in accordance with the switching transistor.

Further, the input-output control portion 102 includes a display circuit control portion (also referred to as DCTL) 121 and a photodetector circuit control portion (also referred to as PDCTL) 122.

The display circuit control portion 121 controls display operation in the display circuit 115d. The display circuit control portion 121 exchanges a datum with circuits in the input-output portion 101 and the data processing portion 103.

The photodetector circuit control portion 122 controls operations of generating and reading an optical datum in the photodetector circuit 115p. The photodetector circuit control portion 122 exchanges data with circuits in the input-output portion 101 and the data processing portion 103.

In addition, the data processing portion 103 includes an image processing circuit (also referred to as IMGP) 131, a memory circuit (also referred to as MEMORY) 132, and a CPU (Central Processing Unit) 133.

The image processing circuit 131 performs a predetermined process on an input optical datum as an image datum. Examples of the predetermined process are a labeling process, an optical data count process, and a coordinate detecting process. For example, the image processing circuit 131 includes a labeling processing circuit imprinting a label on an optical datum, a count circuit counting the number of optical data on each of which the label of the same group is imprinted is counted, and a comparator comparing a count value of the optical data, on each of which the label of the same group is imprinted, with both a first reference count value and a second reference count value.

The memory circuit 132 includes a RAM (Random Access Memory) and a ROM (Read Only Memory). Note that a plurality of RAMs may be included. Further, the ROM stores a datum of a program for performing a predetermined operation, or the like. Note that the number of programs can be set as appropriate.

A command signal is input to the CPU 133 and the CPU 133 performs a program in accordance with the input command signal.

Next, as an example of a method for driving the input-output device in this embodiment, an example of a method for driving the input-output device illustrated in FIG. 1A is described with reference to FIG. 1B. FIG. 1B is a flow chart for illustrating an example of a method for driving the input-output device illustrated in FIG. 1A.

In a method for driving the input-output device in FIG. 1A, a display data signal is input to the display circuit 115d in accordance with a pulse of a display selection signal; after that, the display circuit 115d goes to a display state in accordance with a datum of the input display data signal; then, the pixel portion 101d displays an image.

In an example of a method for driving the input-output device in FIG. 1A, an optical datum is generated (also referred to as generating of an optical datum) as a step S11.

As operation in generating an optical datum, a plurality of optical data in accordance with the illuminance of incident light is generated for a plurality of photodetector circuits 115p every unit period. Note that before an optical datum is generated, the photodetector circuit 115p is made to be in a reset state in accordance with photodetection reset signal. Further, the above unit period is set in accordance with pulses of a photodetection reset signal and an output selection signal which are controlled by the photodetector circuit control portion 122, for example.

Further, optical data generated by the plurality of photodetector circuits 115p are sequentially output as an optical data signal in accordance with an output selection signal. Furthermore, the optical datum output from the plurality of photodetector circuits 115p by the reading circuit 116 are sequentially read and output, so that the optical data signals are sequentially output to the data processing portion 103.

When the optical data signals are input to the data processing portion 103, data (optical data) of the optical data signal are sequentially stored in a memory element in a specified memory address in a RAM of the memory circuit 132. In addition, coordinate information of an optical datum may be stored in the RAM as a coordinate datum. In the case of an analog optical data signal, the optical data signal may be converted into a digital optical data signal.

Next, as a step S12, calculation of an area is performed.

As operation of calculating the area, an optical datum stored in the memory circuit 132 is used as an image datum, and the labeling process is performed by the image processing circuit 131.

In the labeling process, optical data stored in the memory circuit 132 are sequentially read, and then, a label is imprinted on the optical datum by a labeling processing circuit in the case where a value of the read optical datum is larger than a value of a reference datum. The value of the reference datum can be set as appropriate. Before imprinting a label, an optical datum may be subject to a process such as filtering and noise or the like may be removed.

For example, a value of a label is stored in the same address as the memory address of a memory element in which the labeled optical datum is stored, whereby a label is imprinted on an optical datum. Note that “the same address” here means that the addresses in different hierarchy levels of the same RAM are the same, and that the addresses in different RAMs are the same.

The labeled optical datum is an optical datum generated in the photodetector circuit 115p in a portion where the pixel portion 101d and an object to be read overlap one another. Therefore, the position of the object to be read can be detected.

Note that in the case where one object to be read overlaps with the pixel portion 101d, when a label is imprinted on the optical datum generated by the adjacent photodetector circuit 115p, a label is set to become the same kind of label as the imprinted label because labels of the same group are preferably imprinted on optical data in the portion where the object to be read and the pixel portion 101d overlap.

In addition, the number of optical data on each of which the label of the same group is imprinted is counted by the count circuit. The area of the region in which an object to be read and the pixel portion 101d overlap can be easily calculated by the number of optical data on each of which the label of the same group is imprinted.

By the labeling process, the position and the area of the region in which the object to be read and the pixel portion 101d overlap one another can be calculated.

Next, as a step S13, a comparison of areas is made.

As operation of the comparing areas, the comparator in the image processing circuit 131 compares the count value of the optical data on each of which the label of the same group is imprinted, that is, the count value of optical data generated by a photodetector circuit provided in a region in which the pixel portion 101d and an object to be read overlap, with both the first reference count value and the second reference count value; therefore, the region in which the pixel portion 101d and the object to be read overlap is determined.

At that time, a first process is performed as a step S14_1 in the case where the count value (also referred to as CNT(PD)) of optical data on each of which the label of the same group is imprinted is larger than or equal to the first reference count value (also referred to as CNT(ref1)) and smaller than or equal to the second reference count value (also referred to as CNT(ref2)) (CNT (ref1) CNT(PD) CNT(ref2)). Note that the first reference count value is a natural number smaller than the second reference count value, and the second reference count value is a natural number larger than the first reference count value. Further, the first reference count value is made to be larger than 0 and smaller than the second reference count value, whereby the influence of noise in an optical datum can be suppressed.

In the first process, a signal indicating that a count value of optical data on each of which the label of the same group is imprinted is larger than or equal to the first reference count value and smaller than or equal to the second reference count value, is output to the CPU 133 as a command signal, the coordinate of the center of a region of the pixel portion 101 d provided with a photodetector circuit in which optical data on each of which the label of the same group is imprinted is generated are calculated, a datum of the coordinate is output to the CPU 133, and the CPU 133 reads one or more of a plurality of programs from the memory circuit 132 and performs the program(s) in accordance with the coordinate datum.

Further, when the count value of optical data on each of which the label of the same group is imprinted is larger than the second reference count value (CNT(PD)>CNT(ref2)), a second process is performed as a step S14_2.

In the second process, a signal indicating that a count value of optical data, on which label of the same group are imprinted is larger than the second reference count value, is output to the CPU 133 as a command signal, and the CPU 133 reads one or more of a plurality of programs from the memory circuit 132 and performs the program(s) in a region of the pixel portion 101d provided with the photodetector circuit 115p in which optical data on each of which the label of the same group is imprinted is generated.

Note that by the second process, an image signal is generated using an optical datum on which a label of the same group is imprinted, a display data signal is generated on the basis of the image signal, and the generated display data signals may be sequentially output to the plurality of display circuits 115d. The CPU 133 reads one or more of a plurality of programs from the memory circuit 132 and performs the program(s) in accordance with a displayed image.

As described with reference to FIGS. 1A and 1B, in an example of an input-output device in this embodiment, whether coordinates for performing a process in a region in which the object to be read and the pixel portion overlap are single or plural is selected in accordance with an area of the region of the pixel portion with which an object to be read overlaps, in the case where an object to be read overlaps a pixel portion. Thus, new applications utilizing the function can be provided because a process to be performed can be selected in accordance with an area of the region of the pixel portion with which an object to be read overlaps. Therefore, applications utilizing input-output devices can be increased.

Further, in an example of an input-output device in this embodiment, a label is imprinted on an optical datum selectively and the number of optical data on each of which the label of the same group is imprinted is counted, whereby an area of the region of the pixel portion with which an object to be read overlaps is calculated easily. Furthermore, an example of an input-output device in this embodiment compares a count value of optical data and a reference count value and can change a process by the comparison result because of a difference in an area of the region of the pixel portion with which an object to be read overlaps. Therefore, convenience of an input-output device can be improved.

### Embodiment 2

In this embodiment, examples of a function of the input-output device in Embodiment 1 will be described.

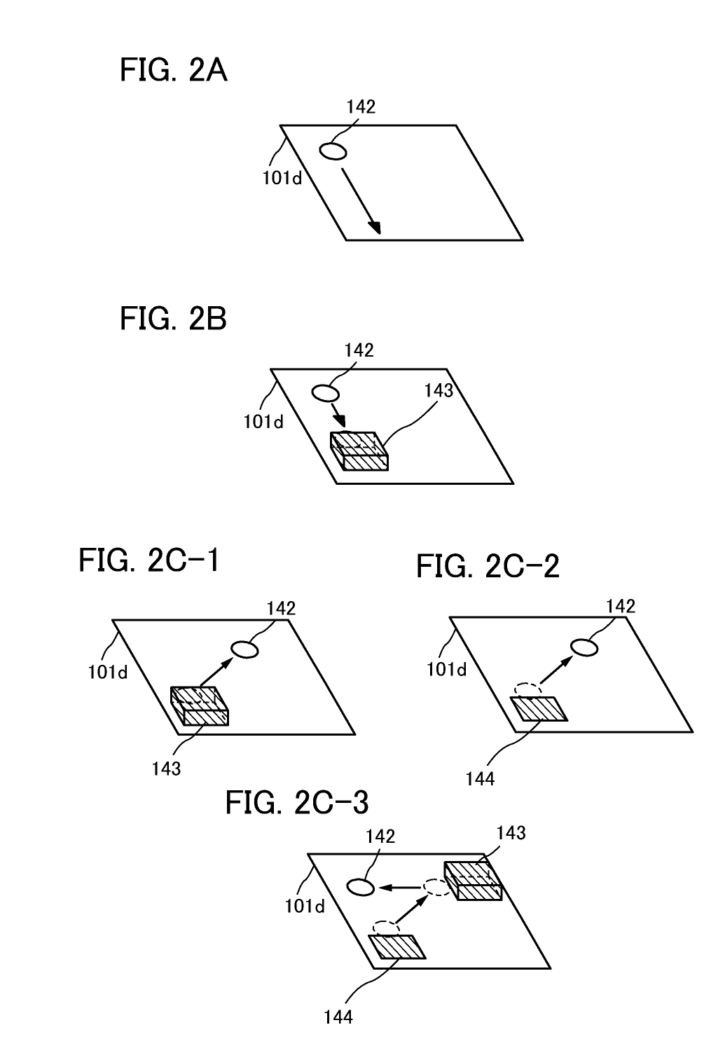

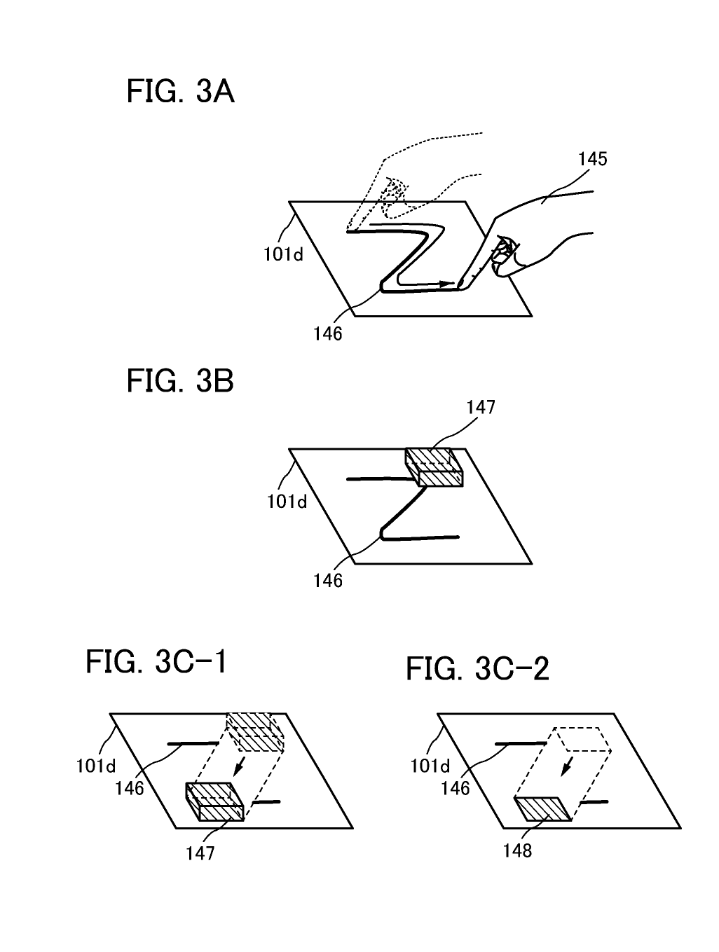

Examples of a function of an input-output device in this embodiment will be described with reference to FIGS. 2A to 2C-3. FIGS. 2A to 2C-3 are schematic views for describing an example of a function of the input-output device in this embodiment.

It is assumed that an image including a circle 142 is displayed on the pixel portion 101d as illustrated in FIG. 2A. For example, the circle 142 moves to a predetermined direction as shown in an arrow in FIG. 2A over time. Further, at that time, an optical datum is generated every unit period by the photodetector circuit 115p in the pixel portion 101d.

Further, as illustrated in FIG. 2B, an object 143 to be read, which is a rectangular solid, overlaps with the pixel portion 101d. At that time, a value of the area of a region of the pixel portion 101d which overlaps the object 143 to be read is larger than a reference value.

Further, operation in area calculation is performed. In the operation of area calculation, a label is imprinted on an optical datum with a value larger than that of a reference datum by the labeling process. Thus, the label of the same group is imprinted on an optical datum generated by the photodetector circuit provided in the region of the pixel portion 101d which overlaps with the object 143 to be read. Further, the number of optical data on each of which the label of the same group is imprinted is counted.

Further, operation in area comparison is performed. The second process is performed when the count value of optical data on which label of the same group are imprinted is judged to be larger than the second reference count value by the operation in the area comparison. By the second process, the CPU 133 is set to change a motion vector of the circle 142 and perform a program for changing a movement direction of the circle 142 when a signal indicating that the count value of the optical data on each of which the label of the same group is imprinted is larger than the second reference count value, is output to the CPU 133, and an image of the circle 142 is displayed in coordinates of a region of the pixel portion 101d which overlaps with the object 143 to be read.

For example, as illustrated in FIG. 2C-1, when the circle 142 is in contact with a region of the pixel portion 101d which overlaps with the object 143 to be read, a program is performed, the motion vector of the circle 142 is changed, and the movement direction of the circle 142 is changed. Therefore, it appears to a viewer that the circle 142 bounces off the object 143 to be read.

As illustrated in FIG. 2C-2, as the second process, when the circle 142 is displayed in the coordinates of the region of the pixel portion 101d which overlaps with the object 143 to be read, a program of changing the motion vector of the circle 142 and the movement direction of the circle 142 is set to be performed; an image datum is generated using an optical datum of the region of the pixel portion 101d which overlaps with the object 143 to be read; an object 144 to be read corresponding to the image datum is displayed on the pixel portion 101d; and the object 143 to be read may be removed. In that case, when coordinates on which the object 144 to be read are displayed are in contact with the circle 142, a program is performed, the motion vector of the circle 142 is changed, and the movement direction of the circle 142 is changed. Therefore, it appears to a viewer that the circle 142 bounces off the object 144 to be read.

Further, as illustrated in FIG. 2C-3 as a combination of FIG. 2C-1 and FIG. 2C-2, as the second process, when the circle 142 is displayed in the coordinates of a region of the pixel portion 101d which overlaps with the object to be read, a program of changing the motion vector of the circle 142 and the movement direction of the circle 142 is set to be performed; after that, an image datum is generated using an optical datum of the region of the pixel portion 101d which overlaps with the object to be read; and an object 144 to be read is displayed on a region of the pixel portion 101d with which the object 143 to be read does not overlap in accordance with the image datum. Note that at that time, the object 144 to be read may be smaller than the object 143 to be read. In that case, when the region of the pixel portion 101d which overlaps with the object 143 to be read is in contact with the circle 142, a program is performed, the motion vector of the circle 142 is changed, and the movement direction of the circle 142 is changed; and when coordinates on which the object 144 to be read are displayed are in contact with the circle 142, a program is performed, the motion vector of the circle 142 is changed, and the movement direction of the circle 142 is changed. Therefore, it appears to a viewer that the circle 142 bounces off the objects 143 and 144 to be read.

As described with reference to FIGS. 2A to 2C-3, the input-output device illustrated in Embodiment 1 can perform a process of controlling operation of a displayed image in accordance with an area of the region of the pixel portion with which an object to be read overlaps. Thus, new applications utilizing the function can be provided. Therefore, applications utilizing input-output devices can be increased.

Note that an example of a function of the input-output device illustrated in Embodiment 2 is not limited to the content shown in this specification. Another example of a function may be employed as long as the device includes a function of changing a process in accordance with an area of the region of the pixel portion with which an object to be read overlaps.

### Embodiment 3

In this embodiment, an example of a function of the input-output device in Embodiment 1 will be described.

An example of a function of an input-output device in this embodiment will be described with reference to FIGS. 3A to 3C-2. FIGS. 3A to 3C-2 are schematic views for describing an example of a function of the input-output device in this embodiment.

First, as illustrated in FIG. 3A, an object 145 to be read, which is a finger, moves in the direction of an arrow in the pixel portion 101d. The area of the object 145 to be read is larger than or equal to the first reference count value and smaller than or equal to the second reference count value. Further, at this time, an optical datum is generated by the photodetector circuit 115p in the pixel portion 101d every unit period.

Further, operation in area calculation is performed. In the operation of area calculation, a label is imprinted on an optical datum with a value larger than that of a reference datum by the labeling process. Thus, labels of the same group are imprinted on optical data generated by the photodetector circuit provided in the region of the pixel portion 101d which overlaps with the object 145 to be read. Further, the number of optical data on each of which the label of the same group is imprinted is counted.

Further, operation in area comparison is performed. The first process is performed when the count value of optical data on each of which the label of the same group is imprinted is judged to be larger than or equal to the first reference count value and smaller than or equal to the second reference count value by the operation in the area comparison. In the first process, a signal of the result that a count value of the optical data which are imprinted with labels of the same group is larger than or equal to the first reference count value and less than or equal to the second reference count value is output to the CPU 133, the coordinate of the center of a region of the pixel portion 101d which overlaps with the object 145 to be read is calculated, and the CPU 133 performs a program for changing an image in the region in the coordinates into an image in a color. By this method, it appears to a viewer that the curved line 146 is drawn in accordance with a track of the object 145 to be read.

Further, as illustrated in FIG. 3B, an object 147 to be read, which is a rectangular solid, overlaps with the pixel portion 101d. At that time, a value of the area of a region of the pixel portion 101d which overlaps with the object 147 to be read is larger than a reference value. Note that the shape of the object 147 to be read is not particularly limited.

Further, operation in area calculation is performed. In the operation of area calculation, a label is imprinted on an optical datum with a value larger than that of a reference datum by the labeling process. Thus, labels of the same group are imprinted on optical data generated by the photodetector circuit provided in the region of the pixel portion 101d which overlaps with the object 147 to be read. Further, the number of optical data on each of which the label of the same group is imprinted is counted.

Further, operation in area comparison is performed. The second process is performed when the count value of optical data on each of which the label of the same group is imprinted is judged to be larger than the second reference count value by the operation in the area comparison. In the second process, a signal indicating that the count value of the optical data on each of which the label of the same group is imprinted is larger than the second reference count value is output to the CPU 133, and a program for changing an image to a white image is performed in the coordinates of a region of the pixel portion 101d which overlap with the object 147.

For example, as illustrated in FIG. 3C-1, a program is performed and the color of an image in a region of the curved line 146 which the object 147 to be read touches is turned into white when an object 147 to be read moves along a curved line 146 in the direction of an arrow. Accordingly, it appears to a viewer that part of the image of the curved line 146 is erased by touching the object 147 to be read, that is, the object 147 to be read erases part of the curved line 146 as if the object 147 is an eraser.

As illustrated in FIG. 3C-2, as the second process, a program of changing an image into a white image in the coordinates of a region of the pixel portion 101d which overlaps with the object 147 to be read is set to be performed; an image datum is generated using an optical datum of the region of the pixel portion 101d which overlaps with the object 147 to be read; an object 148 to be read corresponding to the image datum is displayed on the pixel portion 101d; and the object 147 to be read may be removed. For example, a program is performed and the color of an image in a region of the curved line 146 which the object 148 to be read touches is turned into white when an object 148 to be read moves along a curved line 146 in the direction of an arrow by a finger or the like. Accordingly, it appears to a viewer that part of the image of the curved line 146 is erased by touching the object 148 to be read, that is, the object 148 to be read erases part of the curved line 146 as if the object 147 is an eraser.

As described with reference to FIGS. 3A to 3C-2, the input-output device illustrated in Embodiment 1 can perform a process of controlling operation of a displayed image in accordance with an area of the region of the pixel portion with which an object to be read overlaps. Thus, new applications utilizing the function can be provided. Therefore, applications utilizing input-output devices can be increased.

Note that an example of a function of the input-output device illustrated in Embodiment 3 is not limited to the content shown in this specification. Another example of a function may be employed as long as the device includes a function of changing a process in accordance with an area of an object to be read.

An example of a function of the input-output device in Embodiment 3 can be combined with an example of a function of the input-output device in Embodiment 2 as appropriate.

### Embodiment 4

In this embodiment, examples of the photodetector circuit in the input-output device of the above embodiment are described.

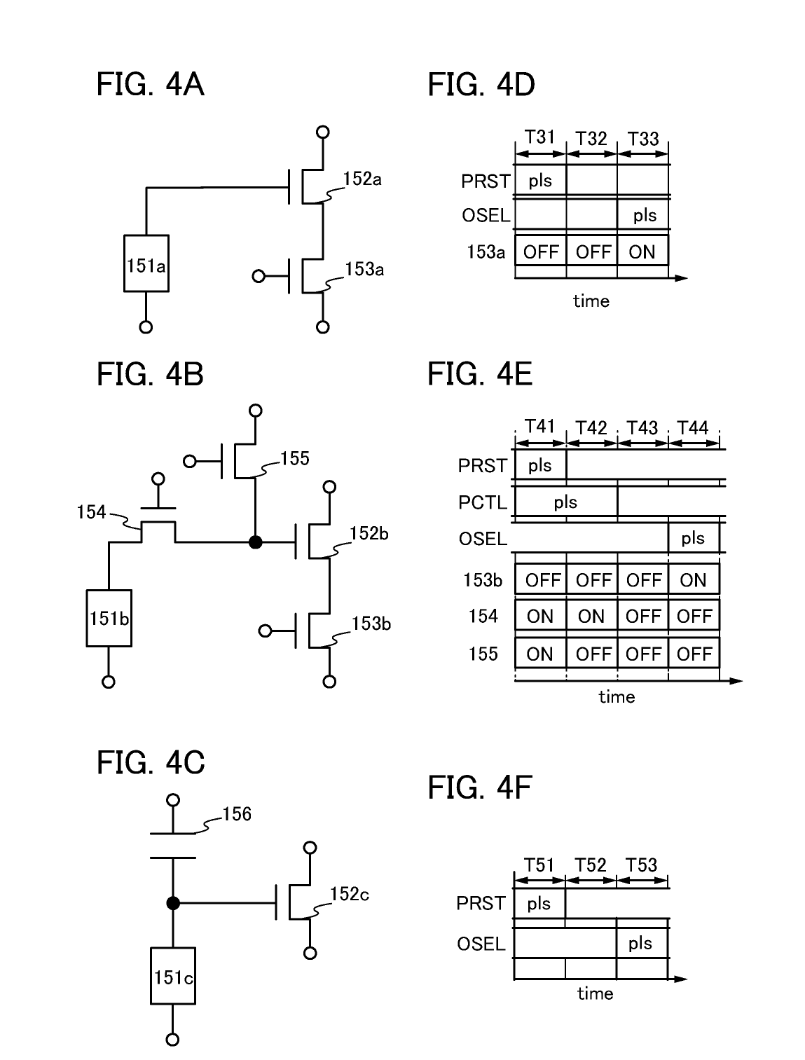

Examples of the photodetector circuit in this embodiment will be described with reference to FIGS. 4A to 4F. FIGS. 4A to 4F illustrate the examples of the photodetector circuit of this embodiment.

First, structural examples of the photodetector circuit of this embodiment will be described with reference to FIGS. 4A to 4C. FIGS. 4A to 4C illustrate the structural examples of the photodetector circuit of this embodiment.

The photodetector circuit illustrated in FIG. 4A includes a photoelectric transducer 151a, a transistor 152a, and a transistor 153a.

Note that in the photodetector circuit illustrated in FIG. 4A, the transistor 152a and the transistor 153a are field-effect transistors.

The photoelectric transducer 151a has a first current terminal and a second current terminal. A signal PRST is input to the first current terminal of the photoelectric transducer 151a.

A gate of the transistor 152a is electrically connected to the second current terminal of the photoelectric transducer 151a.

One of a source and a drain of the transistor 153a is electrically connected to one of a source and a drain of the transistor 152a. A signal OSEL is input to a gate of the transistor 153a.

Voltage Va is applied to either the other of the source and the drain of the transistor 152a or the other of the source and the drain of the transistor 153a.

In addition, the photodetector circuit illustrated in FIG. 4A outputs an optical datum from the rest of the other of the source and the drain of the transistor 152a or the other of the source and the drain of the transistor 153a as an optical data signal.

The photodetector circuit illustrated in FIG. 4B includes a photoelectric transducer 151b, a transistor 152b, a transistor 153b, a transistor 154, and a transistor 155.

Note that in the photodetector circuit illustrated in FIG. 4B, the transistor 152b, the transistor 153b, the transistor 154, and the transistor 155 are field-effect transistors.

The photoelectric transducer 151b has a first current terminal and a second current terminal. Voltage Vb is input to the first current terminal of the photoelectric transducer 151b.

One of a source and a drain of the transistor 154 is electrically connected to the second current terminal of the photoelectric transducer 151b. A photo detection control signal (a signal PCTL) is input to a gate of the transistor 154. The photo detection control signal is a pulse signal.

A gate of the transistor 152b is electrically connected to the other of the source and the drain of the transistor 154.

The voltage Va is applied to one of a source and a drain of the transistor 155. The other of the source and the drain of the transistor 155 is electrically connected to the other of the source and the drain of the transistor 154. A signal PRST is input to a gate of the transistor 155.

One of a source and a drain of the transistor 153b is electrically connected to one of a source and a drain of the transistor 152b. A signal OSEL is input to a gate of the transistor 153b.

The voltage Va is applied to either the other of the source and the drain of the transistor 152b or the other of the source and the drain of the transistor 153b.

In addition, the photodetector circuit illustrated in FIG. 4B outputs an optical datum from the rest of the other of the source and the drain of the transistor 152b or the other of the source and the drain of the transistor 153b as an optical data signal.

Note that when the input-output device includes a plurality of photodetector circuits shown in FIG. 4B, the same photodetection control signal can be input to all the photodetector circuits. A driving method in which the same photodetection control signal is input to all the photodetector circuits to generate an optical datum is also called a global shutter method.

The photodetector circuit in FIG. 4C includes a photoelectric transducer 151c, a transistor 152c, and a capacitor 156.

The photoelectric transducer 151c has a first current terminal and a second current terminal. A signal PRST is input to the first current terminal of the photoelectric transducer 151c.

The capacitor 156 includes a first capacitor electrode and a second capacitor electrode. The signal OSEL is input to the first capacitor electrode of the capacitor 156. The second capacitor electrode of the capacitor 156 is electrically connected to the second current terminal of the photoelectric transducer 151c.

The voltage Va is applied to one of a source and a drain of the transistor 152c. A gate of the transistor 152c is electrically connected to the second current terminal of the photoelectric converter 151c.

Note that the photodetector circuit in FIG. 4C outputs an optical datum as an optical data signal from the other of the source and the drain of the transistor 152c.

Further, the components of the photodetector circuits illustrated in FIGS. 4A to 4C will be described.

As the photoelectric transducers 151a to 151c, photodiodes, phototransistors, or the like can be used. In the case where the photoelectric transducers 151a to 151c are photodiodes, one of an anode and a cathode of the photodiode corresponds to the first current terminal of the photoelectric transducer, and the other of the anode and the cathode of the photodiode corresponds to the second current terminal of the photoelectric transducer. In the case where the photoelectric transducers 151a to 151c are phototransistors, one of a source and a drain of the phototransistor corresponds to the first current terminal of the photoelectric transducer, and the other of the source and the drain of the phototransistor corresponds to the second current terminal of the photoelectric transducer.

The transistors 152a to 152c function as amplifier transistors.

The transistor 154 functions as a photodetection control transistor. A photodetection control transistor has a function of controlling whether or not the voltage of the gate of an amplifier transistor is set to a value determined in accordance with photocurrent flowing through a photoelectric converter. Although the transistor 154 is not necessarily provided in the photodetector circuit of this embodiment, providing the transistor 154 allows the voltage of the gate of the transistor 152b to be held for a certain period of time when the gate of the transistor 152b is in a floating state.

The transistor 155 functions as a photodetection reset transistor. A photodetection reset selection transistor has a function of selecting whether or not the voltage of the gate of the amplifier transistor is set to a reference value.

The transistors 153a and 153b function as output selection transistors.

Note that each of the transistors 152a, 152b, 153a, 153b, 154, and 155 is, for example, a transistor including a semiconductor layer containing a semiconductor that belongs to Group 14 in the periodic table (e.g., silicon) or an oxide semiconductor layer. Channels are formed in the semiconductor layer and the oxide semiconductor layer of the transistors. For example, with the use of the transistor including the oxide semiconductor layer, fluctuation in gate voltage due to the leakage current of each of the transistors 152a, 152b, 153a, 153b, 154, and 155 can be reduced.

Next, examples of methods for driving the photodetector circuits illustrated in FIGS. 4A to 4C will be described.

First, an example of a method for driving the photodetector circuit illustrated in FIG. 4A will be described with reference to FIG. 4D. FIG. 4D is a timing chart for describing the example of the method for driving the photodetector circuit illustrated in FIG. 4A and illustrates the states of the signal PRST, the signal OSEL, and the transistor 153a. Note that the case where the photoelectric transducer 151a is a photodiode is described as an example here.

In the example of the method for driving the photodetector circuit illustrated in FIG. 4A, first, in a period T31, the pulse (also referred to as pls) of the signal PRST is input. From the period T31 to a period 32, the pulse of the signal PCTL is input. Note that in the period T31, a timing of starting the input of the pulse of the signal PRST may be earlier than a timing of starting the input of the pulse of the signal PCTL.

In that case, the photoelectric transducer 151a is forward-biased, so that the transistor 153a is turned off (also referred to as OFF).

At that time, the voltage of the gate of the transistor 152a is reset to a certain value.

Then, in the period T32 coming after the pulse of the signal PRST is input, the photoelectric transducer 151a is reverse-biased, and the transistor 153a is kept off.

At this time, photocurrent flows between the first current terminal and the second current terminal of the photoelectric transducer 151a in accordance with the illuminance of light incident on the photoelectric transducer 151a. Further, the voltage value of the gate of the transistor 152a is changed in accordance with the photocurrent. In that case, channel resistance between the source and the drain of the transistor 152a is changed.

Then, in a period T33, the pulse of the signal OSEL is input.

At this time, the photoelectric transducer 151a is kept reverse-biased, the transistor 153a is turned on (also referred to as ON), and current flows through the source and the drain of the transistor 152a and the source and the drain of the transistor 153a. The amount of the current flowing through the source and the drain of the transistor 152a and the source and the drain of the transistor 153a depends on the voltage value of the gate of the transistor 152a. Thus, an optical datum has a value based on the illuminance of light incident on the photoelectric transducer 151a. In addition, the photodetector circuit illustrated in FIG. 4A outputs an optical datum from the rest of the other of the source and the drain of the transistor 152a or the other of the source and the drain of the transistor 153a as an optical data signal. This is the example of the method for driving the photodetector circuit illustrated in FIG. 4A.

Next, an example of a method for driving the photodetector circuit illustrated in FIG. 4B will be described with reference to FIG. 4E. FIG. 4E is a timing chart for describing the example of the method for driving the photodetector circuit illustrated in FIG. 4B.

In the example of the method for driving the photodetector circuit illustrated in FIG. 4B, first, in a period T41, the pulse of the signal PRST is input. In the period T41 and a period T42, the pulse of the signal PCTL is input. Note that in the period T41, a timing of starting the input of the pulse of the signal PRST may be earlier than timing of starting the input of the signal PCTL.

At this time, in the period T41, the photoelectric transducer 151b is forward-biased, and the transistor 154 is turned on, so that the voltage value of the gate of the transistor 152b is reset to a value equivalent to the value of the voltage Va.

Further, in the period T42 coming after the pulse of the signal PRST is input, the photoelectric transducer 151b is reverse-biased, the transistor 154 is kept on, and the transistor 155 is turned off.

At this time, photocurrent flows between the first current terminal and the second current terminal of the photoelectric transducer 151b in accordance with the illuminance of light incident on the photoelectric transducer 151b. Further, the voltage value of the gate of the transistor 152b is changed in accordance with the photocurrent. In this case, channel resistance between the source and the drain of the transistor 152b is changed.

Further, in a period T43 coming after the signal PCTL is input, the transistor 154 is turned off.

At this time, the voltage of the gate of the transistor 152b is kept being a value determined in accordance with the photocurrent of the photoelectric transducer 151b in the period T42. Although the period T43 is not necessarily provided, providing the period T43 allows a timing of outputting a data signal in the photodetector circuit to be set as appropriate. For example, a timing of outputting a data signal in each of the plurality of photodetector circuits can be set as appropriate.

In a period T44, the pulse of the signal OSEL is input.

At this time, the photoelectric transducer 151b is kept reverse-biased and the transistor 153b is turned on.

Further at this time, current flows through the source and the drain of the transistor 152b and the source and the drain of the transistor 153b, and the photodetector circuit illustrated in FIG. 4B outputs an optical datum as a data signal from the rest of the other of the source and the drain of the transistor 152b or the other of the source and the drain of the transistor 153b. This is the example of the method for driving the photodetector circuit illustrated in FIG. 4B.

Next, an example of a driving method of the photodetector circuit in FIG. 4C will be described with reference to FIG. 4F. FIG. 4F is a timing chart for describing the example of the method for driving the photodetector circuit illustrated in FIG. 4C.

In the example of the method for driving the photodetector circuit illustrated in FIG. 4C, first, in a period T51, the pulse of the signal PRST is input.

At this time, the photoelectric transducer 151c is forward-biased and the voltage of the gate of the transistor 152c is reset to a certain value.

Then, in a period T52 coming after the pulse of the signal PRST is input, the photoelectric transducer 151c is reverse-biased.

At this time, photocurrent flows between the first current terminal and the second current terminal of the photoelectric transducer 151c in accordance with the illuminance of light incident on the photoelectric transducer 151c. Further, the voltage of the gate of the transistor 152c is changed in accordance with the photocurrent. In that case, the resistance value of a channel between the source and the drain of the transistor 152c is changed.

Then, in a period T53, the pulse of the signal OSEL is input.

At that time, the photoelectric transducer 151c is kept reverse-biased, a current flows between the source and the drain of the transistor 152c, and the photodetector circuit in FIG. 4C outputs an optical datum as a data signal from the other of the source and the drain of the transistor 152c. This is the example of the method for driving the photodetector circuit illustrated in FIG. 4C.

As described with reference to FIGS. 4A to 4F, the examples of the photodetector circuit of this embodiment each includes the photoelectric transducer and the amplifier transistor. In the example of the photodetector circuit of this embodiment, an optical datum is generated and is output as a data signal in accordance with an output selection signal. With such a structure, the photodetector circuit can generate and output an optical datum.

### Embodiment 5

In this embodiment, examples of the display circuit in the input-output device of the above embodiment are described.

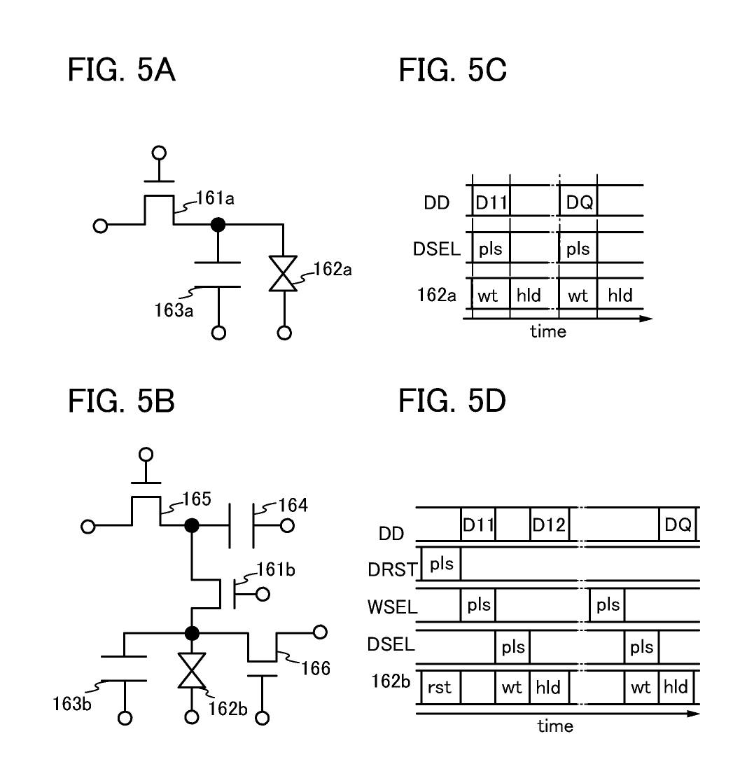

Examples of the display circuit of this embodiment are described with reference to FIGS. 5A to 5D. FIGS. 5A to 5D illustrate the examples of the display circuit of this embodiment.

First, structural examples of the display circuit of this embodiment will be described with reference to FIGS. 5A and 5B. FIGS. 5A and 5B illustrate the structural examples of the display circuit of this embodiment.

The display circuit illustrated in FIG. 5A includes a transistor 161a, a liquid crystal element 162a, and a capacitor 163a.

Note that in the display circuit illustrated in FIG. 5A, the transistor 161a is a field-effect transistor.

In addition, in the input-output device, the liquid crystal element includes a first display electrode, a second display electrode, and a liquid crystal layer. The light transmittance of the liquid crystal layer changes depending on voltage applied between the first display electrode and the second display electrode.

Further, in the input-output device, the capacitor includes a first capacitor electrode, a second capacitor electrode, and a dielectric layer overlapping with the first capacitor electrode and the second capacitor electrode. Electrical charge is accumulated in the capacitor in accordance with voltage applied between the first capacitor electrode and the second capacitor electrode.

A signal DD is input to one of a source and a drain of the transistor 161a, and a signal DSEL is input to a gate of the transistor 161a.

The first display electrode of the liquid crystal element 162a is electrically connected to the other of the source and the drain of the transistor 161a. Voltage Vc is input to the second display electrode of the liquid crystal element 162a. The value of the voltage Vc can be set as appropriate.

The first capacitor electrode of the capacitor 163a is electrically connected to the other of the source and the drain of the transistor 161a. The voltage Vc is input to the second capacitor electrode of the capacitor 163a.

The display circuit illustrated in FIG. 5B includes a transistor 161b, a liquid crystal element 162b, a capacitor 163b, a capacitor 164, a transistor 165, and a transistor 166.

Note that in the display circuit illustrated in FIG. 5B, the transistor 161b, the transistor 165, and the transistor 166 are field-effect transistors.

A signal DD is input to one of a source and a drain of the transistor 165. A write selection signal (a signal WSEL) that is a pulse signal is input to a gate of the transistor 165.

A first capacitor electrode of the capacitor 164 is electrically connected to the other of the source and the drain of the transistor 165. The voltage Vc is input to a second capacitor electrode of the capacitor 164.

One of a source and a drain of the transistor 161b is electrically connected to the other of the source and the drain of the transistor 165. A signal DSEL is input to a gate of the transistor 161b.

A first display electrode of the liquid crystal element 162b is electrically connected to the other of the source and the drain of the transistor 161b. The voltage Vc is input to a second display electrode of the liquid crystal element 162b.

A first capacitor electrode of the capacitor 163b is electrically connected to the other of the source and the drain of the transistor 161b. The voltage Vc is input to a second capacitor electrode of the capacitor 163b. The value of the voltage Vc is set as appropriate in accordance with the specifications of the display circuit.

Reference voltage is input to one of a source and a drain of the transistor 166. The other of the source and the drain of the transistor 166 is electrically connected to the other of the source and the drain of the transistor 161b. A display reset signal (a signal DRST) that is a pulse signal is input to a gate of the transistor 166.

Further, the components of the display circuits illustrated in FIGS. 5A and 5B will be described.

The transistors 161a and 161b function as display selection transistors.

As each of the liquid crystal layers of the liquid crystal elements 162a and 162b, a liquid crystal layer for transmitting light when voltage applied to a first display electrode and a second display electrode is 0 V can be used. For example, a liquid crystal layer containing an electrically controlled birefringence liquid crystal (ECB liquid crystal), a liquid crystal to which a dichroic pigment is added (a GH liquid crystal), a polymer dispersed liquid crystal, or a discotic liquid crystal can be used. A liquid crystal layer exhibiting a blue phase may be used as the liquid crystal layer. The liquid crystal layer exhibiting a blue phase contains, for example, a liquid crystal composition including a liquid crystal exhibiting a blue phase and a chiral agent. The liquid crystal exhibiting a blue phase has a short response time of 1 ms or less and is optically isotropic, which makes the alignment process unneeded and the viewing angle dependence small. Thus, with the liquid crystal exhibiting a blue phase, operation speed can be improved.

The capacitor 163a functions as a storage capacitor in which voltage whose value is based on the signal DD is applied between the first capacitor electrode and the second capacitor electrode in response to the behavior of the transistor 161a. The capacitor 163b functions as a storage capacitor in which voltage whose value is based on the signal DD is applied between the first capacitor electrode and the second capacitor electrode in response to the behavior of the transistor 161b. The capacitors 163a and 163b are not necessarily provided; however, with the capacitors 163a and 163b, fluctuation in voltage applied to the liquid crystal elements due to the leakage current of the display selection transistors can be reduced.

The capacitor 164 functions as a storage capacitor in which voltage whose value is based on the signal DD is applied between the first capacitor electrode and the second capacitor electrode in response to the behavior of the transistor 165.

The transistor 165 functions as a write selection transistor for selecting whether the signal DD is input to the capacitor 164.

The transistor 166 functions as a display reset selection transistor for selecting whether voltage applied to the liquid crystal element 162b is reset.

Note that each of the transistors 161a, 161b, 165, and 166 is, for example, a transistor including a semiconductor layer containing a semiconductor that belongs to Group 14 in the periodic table (e.g., silicon) or a transistor including an oxide semiconductor layer. Channels are formed in the semiconductor layer and the oxide semiconductor layer of the transistors.

Next, examples of methods for driving the display circuits illustrated in FIGS. 5A and 5B will be described.

First, an example of a method for driving the display circuit illustrated in FIG. 5A will be described with reference to FIG. 5C. FIG. 5C is a timing chart for describing the example of the method for driving the display circuit illustrated in FIG. 5A, and illustrates the states of the signal DD and the signal DSEL.

In the example of the method for driving the display circuit illustrated in FIG. 5A, the transistor 161a is turned on when the pulse of a signal DSEL is input.

When the transistor 161a is turned on, the signal DD is input to the display circuit, so that the voltage value of the first display electrode of the liquid crystal element 162a and the voltage value of the first capacitor electrode of the capacitor 163a are equivalent to the voltage value of the signal DD.

At this time, the liquid crystal element 162a is set in a written state (a state wt) and the light transmittance of the liquid crystal element 162a is based on the signal DD, so that the display circuit is set in a display state based on a datum of the signal DD (a datum D11 to a datum DQ (Q is a natural number greater than or equal to 2).

Then, the transistor 161a is turned off, and the liquid crystal element 162a is set to be in a hold state (a state hld) and holds voltage applied between the first display electrode and the second display electrode so that the amount of fluctuation in the voltage from an initial value does not exceed a reference value until when the next pulse of the signal DSEL is input. In addition, when the liquid crystal element 162a is in the hold state, the light unit in the input-output device in the above embodiment is lit.

Next, an example of a method for driving the display circuit illustrated in FIG. 5B is described with reference to FIG. 5D. FIG. 5D is a timing chart for describing the example of the method for driving the display circuit illustrated in FIG. 5B.

In the example of the method for driving the display circuit illustrated in FIG. 5B, the transistor 166 is turned on by input of the pulse of a signal DRST, so that the voltage of the first display electrode of the liquid crystal element 162b and the voltage of the first capacitor electrode of the capacitor 163b are reset to reference voltage.

The transistor 165 is turned on by the input of the pulse of a signal WSEL, and the signal DD is input to the display circuit, so that the voltage value of the first capacitor electrode of the capacitor 164 is equivalent to the voltage value of the signal DD.

After that, the transistor 161b is turned on by the input of the pulse of the signal DSEL, so that the voltage value of the first display electrode of the liquid crystal element 162b and the voltage value of the first capacitor electrode of the capacitor 163b are equivalent to the voltage value of the first capacitor electrode of the capacitor 164.

At this time, the liquid crystal element 162b is set in a written state and the light transmittance of the liquid crystal element 162b is based on the signal DD, so that the display circuit is set in a display state based on a datum of the signal DD (the datum D11 to the datum DQ).

Then, the transistor 161b is turned off, and the liquid crystal element 162b is set in a hold state and holds voltage applied between the first display electrode and the second display electrode so that the amount of fluctuation in the voltage from an initial value does not exceed a reference value until when the next pulse of the signal DSEL is input. In addition, when the liquid crystal element 162b is in the hold state, the light unit in the input-output device in the above embodiment is lit.

As described with reference to FIGS. 5A and 5B, in the example of the display circuit of this embodiment, the display selection transistor and the liquid crystal element are provided. With such a structure, the display circuit can be set in a display state based on the signal DD.

Further, as described with reference to FIG. 5B, in the example of the display circuit of this embodiment, the write selection transistor and the capacitor are provided in addition to the display selection transistor and the liquid crystal element. With such a structure, while the liquid crystal element is set in a display state based on a datum of the signal DD, a datum of the next signal DD can be written to the capacitor. Thus, the operation speed of the display circuit can be improved.

### Embodiment 6

In this embodiment, a transistor that can be applied to the transistor in the input-output device described in the above embodiments will be described.

As the transistor in the input-output device described in the above embodiment, it is possible to use a transistor including an oxide semiconductor layer or a semiconductor layer containing a semiconductor that belongs to Group 14 of the periodic table (e.g., silicon), in which a channel is formed. Note that a layer in which a channel is formed is also referred to as a channel formation layer.

The semiconductor layer may be a single crystal semiconductor layer, a polycrystalline semiconductor layer, a microcrystalline semiconductor layer, or an amorphous semiconductor layer.

In the input-output device described in the above embodiment, as the transistor including the oxide semiconductor layer, for example, a transistor including an oxide semiconductor layer that is highly purified to be intrinsic (also referred to as i-type) or substantially intrinsic can be used. Purification is a general idea including the following cases: the case where hydrogen or water in an oxide semiconductor layer is removed as much as possible and the case where oxygen is supplied to an oxide semiconductor layer and defects due to oxygen deficiency of the oxide semiconductor layer are reduced.

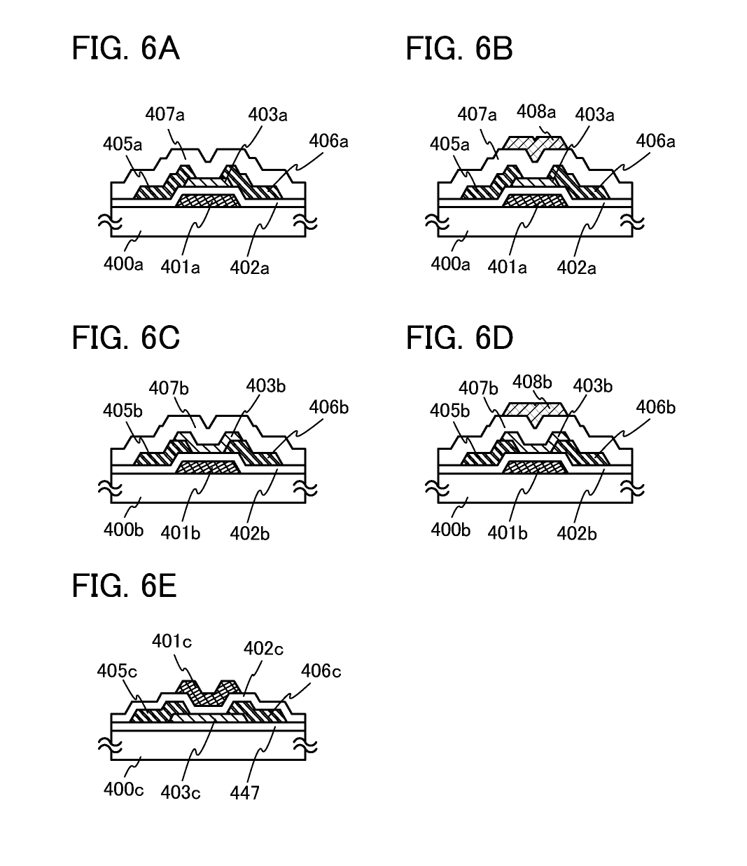

Examples of structures of the transistor including the oxide semiconductor layer will be described with reference to FIGS. 6A to 6E. FIGS. 6A to 6E are schematic cross-sectional diagrams each illustrating an example of the structure of a transistor in this embodiment.

The transistor illustrated in FIG. 6A is one of bottom-gate transistors, which is also referred to as an inverted staggered transistor.

The transistor in FIG. 6A includes a conductive layer 401a, an insulating layer 402a, an oxide semiconductor layer 403a, a conductive layer 405a, and a conductive layer 406a.

The conductive layer 401a is formed over a substrate 400a.

The insulating layer 402a is formed over the conductive layer 401a.

The oxide semiconductor layer 403a overlaps with the conductive layer 401a with the insulating layer 402a interposed therebetween.

The conductive layer 405a and the conductive layer 406a are each provided over part of the oxide semiconductor layer 403a.

Further, in the transistor illustrated in FIG. 6A, part of a top surface of the oxide semiconductor layer 403a (part of the oxide semiconductor layer 403a over which neither the conductive layer 405a nor the conductive layer 406a is provided) is in contact with an insulating layer 407a.

In addition, the insulating layer 407a is in contact with the insulating layer 402a in a portion without the conductive layer 405a, the conductive layer 406a, or the oxide semiconductor layer 403a.

A transistor in FIG. 6B includes a conductive layer 408a in addition to the components in FIG. 6A.

The conductive layer 408a overlaps with the oxide semiconductor layer 403a with the insulating layer 407a interposed therebetween.

A transistor illustrated in FIG. 6C is a kind of bottom-gate transistor.

The transistor illustrated in FIG. 6C includes a conductive layer 401b, an insulating layer 402b, an oxide semiconductor layer 403b, a conductive layer 405b, and a conductive layer 406b.

The conductive layer 401b is formed over a substrate 400b.

The insulating layer 402b is formed over the conductive layer 401b.

The conductive layer 405b and the conductive layer 406b are formed over part of the insulating layer 402b.

The oxide semiconductor layer 403b overlaps with the conductive layer 401b with the insulating layer 402b interposed therebetween.

Further, in FIG. 6C, an upper surface and side surfaces of the oxide semiconductor layer 403b in the transistor are in contact with an oxide insulating layer 407b.

Further, the insulating layer 407b is in contact with the insulating layer 402b in a portion without the conductive layer 405b, the conductive layer 406b, and the oxide semiconductor layer 403b.

Note that in FIGS. 6A to 6C, a protective insulating layer may be provided over the insulating layer.

A transistor in FIG. 6D includes a conductive layer 408b in addition to the components in FIG. 6C.

The conductive layer 408b overlaps with the oxide semiconductor layer 403b with the insulating layer 407b interposed therebetween.

A transistor illustrated in FIG. 6E is a kind of top-gate transistor.

The transistor illustrated in FIG. 6E includes a conductive layer 401c, an insulating layer 402c, an oxide semiconductor layer 403c, a conductive layer 405c, and a conductive layer 406c.

The oxide semiconductor layer 403c is formed over a substrate 400c with an insulating layer 447 interposed therebetween.

The conductive layer 405c and the conductive layer 406c are formed over the oxide semiconductor layer 403c.

The insulating layer 402c is formed over the oxide semiconductor layer 403c, the conductive layer 405c, and the conductive layer 406c.

The conductive layer 401c overlaps with the oxide semiconductor layer 403c with the insulating layer 402c interposed therebetween.

Further, components illustrated in FIGS. 6A to 6E will be described.

As the substrates 4001 to 400c, substrates having translucency can be used, for example. As the substrates having translucency, glass substrates or plastic substrate can be used, for example.

Each of the conductive layers 401a to 401c functions as a gate of the transistor.

Note that a layer functioning as a gate of the transistor can be called a gate electrode or a gate wiring.

Each of the conductive layers 401a to 401c can be, for example, a layer of a metal material such as molybdenum, titanium, chromium, tantalum, tungsten, aluminum, copper, neodymium, or scandium; or an alloy material containing any of these materials as a main component. The conductive layers 401a to 401c can also be formed by stacking layers of materials which can be applied to the conductive layers 401a to 401c.

Each of the insulating layers 402a to 402c serves as a gate insulating layer of the transistor. Note that a layer functioning as a gate insulating layer of the transistor can be called a gate insulating layer.

As the insulating layers 402a to 402c, a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, or a hafnium oxide layer can be used, for example. The insulating layers 402a to 402c can also be formed by stacking layers of materials which can be used for the insulating layers 402a to 402c.

In addition, as the insulating layers 402a to 402c, an insulating layer of a material containing, for example, an element that belongs to Group 13 in the periodic table and oxygen can be used. When the oxide semiconductor layers 403a to 403c contain an element that belongs to Group 13, use of insulating layers containing an element that belongs to Group 13 as insulating layers in contact with the oxide semiconductor layers 403a to 403c makes the state of the interfaces between the insulating layers and the oxide semiconductor layers favorable.

Examples of the material including an element that belongs to Group 13 include gallium oxide, aluminum oxide, aluminum gallium oxide, and gallium aluminum oxide. Note that aluminum gallium oxide refers to a substance in which the amount of aluminum is larger than that of gallium in atomic percent, and gallium aluminum oxide refers to a substance in which the amount of gallium is larger than or equal to that of aluminum in atomic percent.

For example, use of an insulating layer containing gallium oxide as each of the insulating layers 402a to 402c can reduce the accumulation of hydrogen or hydrogen ions at the interfaces between the insulating layer 402a and the oxide semiconductor layer 403a, the insulating layer 402b and the oxide semiconductor layer 403b, and the insulating layer 402c and the oxide semiconductor layer 403c.

In addition, for example, using an insulating layer containing aluminum oxide as each of the insulating layers 402a to 402c can reduce the accumulation of hydrogen or hydrogen ions at the interfaces between the insulating layer 402a and the oxide semiconductor layer 403a, the insulating layer 402b and the oxide semiconductor layer 403b, and the insulating layer 402c and the oxide semiconductor layer 403c. An insulating layer containing aluminum oxide is less likely to transmit water; thus, use of an insulating layer containing aluminum oxide can reduce entry of water to the oxide semiconductor layer through the insulating layer.

As the insulating layers 402a to 402c, a material represented by Al₂Oₓ (x=3+α, where α is larger than 0 and smaller than 1), Ga₂Oₓ(x=3+α, where α is larger than 0 and smaller than 1), or GaₓAl₂₋ₓO_{3+α} (x is larger than 0 and smaller than 2 and α is larger than 0 and smaller than 1) can be used, for example. Each of the insulating layers 402a to 402c can be a stack of layers of materials which can be used for the insulating layers 402a to 402c. For example, each of the insulating layers 402a to 402c can be a stack of layers containing gallium oxide represented by Ga₂Oₓ. Alternatively, each of the insulating layers 402a to 402c can be a stack of an insulating layer containing gallium oxide represented by Ga₂Oₓ and an insulating layer containing aluminum oxide represented by Al₂Oₓ.

The insulating layer 447 serves as a base layer preventing the diffusion of an impurity element coming from the substrate 400c.

The insulating layer 447 can be, for example, a layer of a material which can be used for the insulating layers 402a to 402c. Alternatively, the insulating layer 447 can be a stack of layers of materials which can be used for the insulating layers 402a to 402c.

Each of the oxide semiconductor layers 403a to 403c serves as a layer in which a channel of the transistor is formed. Note that the layer in which a channel of the transistor is formed is also referred to as a channel formation layer. As an oxide semiconductor which can be used for the oxide semiconductor layers 403a to 403c, for example, an In-based oxide, a Sn-based oxide, or a Zn-based oxide. For example, as the above metal oxide, a four-component metal oxide, a three-component metal oxide, a two-component metal oxide, or the like can be given. Note that a metal oxide which can be used as the above oxide semiconductor may include gallium as a stabilizer for reducing variation in characteristics. A metal oxide which can be used as the above oxide semiconductor may include tin as a stabilizer. A metal oxide which can be used as the above oxide semiconductor may include hafnium as a stabilizer. A metal oxide which can be used as the above oxide semiconductor may include aluminum as a stabilizer. A metal oxide which can be used as the above oxide semiconductor may include one or more of following material as a stabilizer: lanthanum, cerium, praseodymium, neodymium, samarium, europium, gadolinium, terbium, dysprosium, holmium, erbium, thulium, ytterbium, and lutetium, which are lanthanoid. Further, the metal oxide that can be used as the oxide semiconductor may contain silicon oxide. For example, as a quaternary metal oxide, an In—S—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, an In—Hf—Al—Zn-based oxide, or the like can be used. For example, as a ternary metal oxide, an In—Ga—Zn-based oxide (also referred to as IGZO), an In—Sn—Zn-based oxide (also referred to as ITZO), an In—Al—Zn-based oxide, Sn—Ga—Zn-based oxide, an Al—Ga—Zn-based oxide, a Sn—Al—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, or the like can be used. As a binary metal oxide, an In—Zn-based oxide (also referred to as IZO), a Sn—Zn-based oxide, an Al—Zn-based oxide, a Zn—Mg-based oxide, a Sn—Mg-based oxide, an In—Mg-based oxide, an In—Sn-based oxide, an In—Ga-based oxide, or the like can be used. Further, the metal oxide that can be used as the oxide semiconductor may contain silicon oxide.

Note that, for example, an In—Ga—Zn-based oxide means an oxide containing In, Ga, and Zn, and there is no limitation on the composition ratio of In, Ga, and Zn. Further, a metal element in addition to In, Ga, and Zn may be contained.

In the case where an In—Zn-based oxide is used, for example, an oxide target having the following composition ratios can be used for deposition of an In—Zn-based oxide semiconductor layer: In:Zn=50:1 to 1:2 (In₂O₃:ZnO=25:1 to 1:4 in a molar ratio), preferably In:Zn=20:1 to 1:1 (In₂O₃:ZnO=10:1 to 1:2 in a molar ratio), more preferably In:Zn=15:1 to 1.5:1 (In₂O₃:ZnO=15:2 to 3:4 in a molar ratio). For example, when the atomic ratio of the target used for the deposition of the In—Zn-based oxide semiconductor is expressed by In:Zn:O=P:W:R, R>1.5P+W. The increase in In content makes the mobility of the transistor higher.

As the oxide semiconductor, a material represented by InMO₃(ZnO)ₘ (m is larger than 0) can be used. Here, M in InMO₃(ZnO)ₘ represents one or more metal elements selected from Ga, Al, Mn, and Co.

The conductive layers 405a to 405c and the conductive layers 406a to 406c each function as a source or a drain of the transistor. Note that a layer functioning as a source of a transistor is also referred to as a source electrode or a source wiring, and a layer functioning as a drain of a transistor is also referred to as a drain electrode or a drain wiring.

Each of the conductive layers 405a to 405c and the conductive layers 406a to 406c can be, for example, a layer of a metal material such as aluminum, chromium, copper, tantalum, titanium, molybdenum, or tungsten; or an alloy material containing the metal material as a main component. Alternatively, each of the conductive layers 405a to 405c and each of the conductive layers 406a to 406c can be a stack of layers of materials which can be used for the conductive layers 405a to 405c and the conductive layers 406a to 406c.

Alternatively, each of the conductive layers 405a to 405c and the conductive layers 406a to 406c can be a layer containing a conductive metal oxide. As the conductive metal oxide, indium oxide, tin oxide, zinc oxide, an alloy of indium oxide and tin oxide, or an alloy of indium oxide and zinc oxide can be used, for example. Note that the conductive metal oxide which can be used for each of the conductive layers 405a to 405c and the conductive layers 406a to 406c may contain silicon oxide.

Like the insulating layers 402a to 402c, as the insulating layers 407a and 407b, an insulating layer of a material containing, for example, an element that belongs to Group 13 in the periodic table and oxygen can be used. Alternatively, for the insulating layers 407a and 407b, a material represented by Al₂Oₓ, Ga₂Oₓ, or GaₓAl₂₋ₓO_{3+α} can be used.

For example, each of the insulating layers 402a to 402c and the insulating layers 407a and 407b can be an insulating layer containing gallium oxide represented by Ga₂Oₓ. Alternatively, the insulating layers 402a to 402c or the insulating layers 407a and 407b may be insulating layers containing gallium oxide represented by Ga₂Oₓ, and the other of the insulating layers 402a to 402c and the insulating layers 407a and 407b may be insulating layers containing aluminum oxide represented by Al₂Oₓ.

The conductive layers 408a and 408b each function as a gate of the transistor. Note that when the transistor includes the conductive layer 408a or the conductive layer 408b, one of the conductive layer 401a and the conductive layer 408a, or one of the conductive layer 401b and the conductive layer 408b is called a back gate, a back gate electrode, or a back gate line. By providing a plurality of layers serving as gates with a channel formation layer interposed therebetween, the threshold voltage of the transistor can be controlled.

Each of the conductive layers 408a and 408b can be, for example, a layer of a metal material such as aluminum, chromium, copper, tantalum, titanium, molybdenum, or tungsten; or an alloy material containing the metal material as a main component. Alternatively, each of the conductive layers 408a and 408b can be a stack of layers of materials which can be used for the conductive layers 408a and 408b.

Alternatively, each of the conductive layers 408a and 408b can be a layer containing a conductive metal oxide. As the conductive metal oxide, indium oxide, tin oxide, zinc oxide, an alloy of indium oxide and tin oxide, or an alloy of indium oxide and zinc oxide can be used, for example. Note that the conductive metal oxide which can be used for the conductive layers 408a and 408b may contain silicon oxide.

Note that the transistor of this embodiment may have an insulating layer over a part of the oxide semiconductor layer serving as a channel formation layer and include a conductive layer serving as a source or a drain and overlapping with the oxide semiconductor layer with the insulating layer therebetween. Consequently, the insulating layer serves as a layer protecting the channel formation layer (also referred to as a channel protective layer) of the transistor. Examples of the insulating layer serving as a channel protective layer include a layer of a material that can be used for the insulating layers 402a to 402c and a stack of layers of materials that can be used for the insulating layers 402a to 402c.

Note that the transistor in this embodiment does not necessarily have the structure where the entire oxide semiconductor overlaps with the conductive layer serving as a gate electrode as illustrated in FIGS. 6A to 6E; in the case of employing the structure where the entire oxide semiconductor overlaps with the conductive layer serving as a gate electrode, entry of light into the oxide semiconductor layer can be prevented.

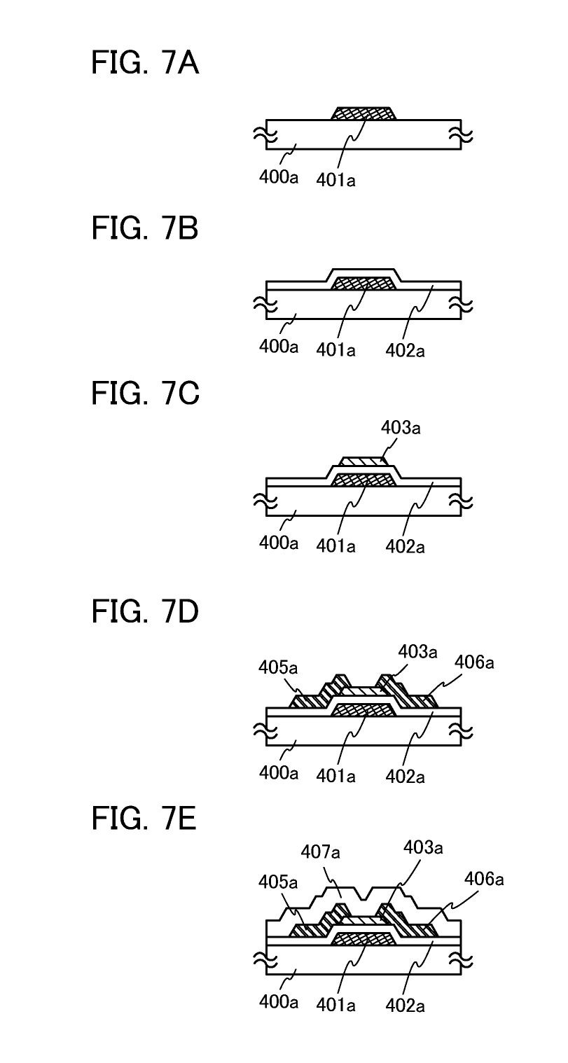

Next, as an example of a method for manufacturing the transistor in this embodiment, an example of a method for manufacturing the transistor illustrated in FIG. 6A will be described with reference to FIGS. 7A to 7E. FIGS. 7A to 7E are schematic cross-sectional views illustrating an example of a method for manufacturing the transistor in FIG. 6A.

First, as illustrated in FIG. 7A, the substrate 400a is prepared, a first conductive film is formed over the substrate 400a, and part of the first conductive film is etched to form the conductive layer 401a.

For example, the first conductive film can be formed by formation of a film of a material applicable to the conductive layer 401 a by sputtering. Alternatively, the first conductive film can be formed by stacking films of materials that can be used for the conductive layer 401a.

When a high-purity gas from which impurities such as hydrogen, water, a hydroxyl group, or a hydride are removed is used as a sputtering gas, the impurity concentration of a film to be formed can be reduced.

Note that before the film is formed by sputtering, preheat treatment may be performed in a preheating chamber of a sputtering apparatus. By the preheat treatment, impurities such as hydrogen or moisture can be eliminated.

Moreover, before the film is formed by sputtering, it is possible to perform the following treatment (called reverse sputtering): instead of applying a voltage to the target side, an RF power source is used for applying a voltage to the substrate side in an argon, nitrogen, helium, or oxygen atmosphere so that plasma is generated to modify a surface where the film is to be formed. With reverse sputtering, powdery substances (also referred to as particles or dust) attached to the surface where the film is to be formed can be removed.

In the case where the film is formed by sputtering, moisture remaining in a deposition chamber for the film can be removed by an entrapment vacuum pump or the like. As the entrapment vacuum pump, a cryopump, an ion pump, or a titanium sublimation pump can be used, for example. Alternatively, moisture remaining in the deposition chamber can be removed by a turbo molecular pump provided with a cold trap.

As a method for forming the conductive layer 401a, the example of a method for forming the transistor of this embodiment employs, for example, the following steps in order to form a layer by etching part of a film: a resist mask is formed over part of the film by a photolithography process and the film is etched using the resist mask, thereby forming the layer. Note that in this case, the resist mask is removed after the layer is formed.

Note that the resist mask may be formed by an inkjet method. A photomask is not used in an inkjet method; thus, manufacturing cost can be reduced. Alternatively, the resist mask may be formed using a light-exposure mask having a plurality of regions with different transmittances (also referred to as a multi-tone mask). With a multi-tone mask, a resist mask having different thicknesses can be formed, and the number of resist masks used for manufacturing the transistor can be reduced.

Next, as illustrated in FIG. 7B, the insulating layer 402a is formed by formation of a first insulating film over the conductive layer 401a.

For example, the first insulating film can be formed by formation of a film of a material applicable to the insulating layer 402a by sputtering, plasma CVD, or the like. The first insulating film can also be formed by stacking films of materials that can be used for the insulating layer 402a. Moreover, when a film of a material applicable to the insulating layer 402a is formed by high-density plasma CVD (e.g., high-density plasma CVD using microwaves at a frequency of 2.45 GHz), the insulating layer 402a can be dense and has an improved breakdown voltage.

Next, an oxide semiconductor film is formed over the insulating layer 402a and then part of the oxide semiconductor film is etched, whereby the oxide semiconductor layer 403a is formed as illustrated in FIG. 7C.

For example, the oxide semiconductor film can be formed by formation of a film of an oxide semiconductor material applicable to the oxide semiconductor layer 403a by sputtering. Note that the oxide semiconductor film may be formed in a rare gas atmosphere, an oxygen atmosphere, or a mixed atmosphere of a rare gas and oxygen.

The oxide semiconductor film can be formed using an oxide target having a composition ratio of In₂O₃:Ga₂O₃:ZnO=1:1:1 [molar ratio] as a sputtering target. Alternatively, the oxide semiconductor film may be formed using an oxide target having a composition ratio of In₂O₃:Ga₂O₃:ZnO=1:1:2 [molar ratio] as a sputtering target.

When the oxide semiconductor film is formed by sputtering, the substrate 400a may be placed under reduced pressure and heated to 100° C. to 600° C., preferably 200° C. to 400° C. By heating of the substrate 400a, the impurity concentration in the oxide semiconductor film can be lowered and damage to the oxide semiconductor film during the sputtering can be reduced.

Next, as illustrated in FIG. 7D, a second conductive film is formed over the insulating layer 402a and the oxide semiconductor layer 403a, and part of the second conductive film is etched to form the conductive layers 405a and 406a.

For example, the second conductive film can be formed by formation of a film of a material applicable to the conductive layers 405a and 406a by sputtering. Alternatively, the second conductive film can be formed by stacking films of materials applicable to the conductive layers 405a and 406a.

Then, as illustrated in FIG. 7E, the insulating layer 407a is formed so as to be in contact with the oxide semiconductor layer 403a.

For example, the insulating layer 407a is a film, which can be used for the insulating layer 407a, formed in a rare gas (typically, argon) atmosphere, an oxygen atmosphere, or a mixed atmosphere of a rare gas and oxygen by sputtering. Forming the insulating layer 407a by sputtering can suppress the decrease in the resistance of part of the oxide semiconductor layer 403a that functions as a back channel of the transistor. The temperature of the substrate at the time of the formation of the insulating layer 407a is preferably higher than or equal to room temperature and lower than or equal to 300° C.

Before the formation of the insulating layer 407a, plasma treatment using a gas such as N₂O, N₂, or Ar may be performed so that water or the like adsorbed onto an exposed surface of the oxide semiconductor layer 403a is removed. In the case where the plasma treatment is performed, the insulating layer 407a is preferably formed after the plasma treatment without exposure to air.

In addition, in the example of the method for forming the transistor illustrated in FIG. 6A, heat treatment is performed at higher than or equal to 400° C. and lower than or equal to 750° C., or higher than or equal to 400° C. and lower than the strain point of the substrate, for example. For example, the heat treatment may be performed after the oxide semiconductor film is formed, after part of the oxide semiconductor film is etched, after the second conductive film is formed, after part of the second conductive film is etched, or after the insulating layer 407a is formed.

Note that a heat treatment apparatus for the heat treatment can be an electric furnace or an apparatus for heating an object by heat conduction or heat radiation from a heater such as a resistance heater. For example, an RTA (rapid thermal anneal) apparatus such as a GRTA (gas rapid thermal anneal) apparatus, or an LRTA (lamp rapid thermal anneal) apparatus can be used. An LRTA apparatus is an apparatus for heating an object by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus with which heat treatment is performed using a high-temperature gas. As the high-temperature gas, for example, a rare gas or an inert gas (e.g., nitrogen) which does not react with an object by heat treatment can be used.

After the heat treatment, a high-purity oxygen gas, a high-purity N₂O gas, or ultra-dry air (with a dew point of −40° C. or lower, preferably −60° C. or lower) may be introduced into the furnace that has been used in the above heat treatment while the heating temperature is being maintained or being decreased. In this case, it is preferable that water, hydrogen, and the like be not contained in the oxygen gas or the N₂O gas. The purity of the oxygen gas or the N₂O gas which is introduced into the heat treatment apparatus is preferably 6N or higher, more preferably 7N or higher. That is, the impurity concentration in the oxygen gas or the N₂O gas is 1 ppm or lower, preferably 0.1 ppm or lower. By the action of the oxygen gas or the N₂O gas, oxygen is supplied to the oxide semiconductor layer 403a, so that defects caused by oxygen deficiency in the oxide semiconductor layer 403a can be reduced.

Further, in addition to the heat treatment, after the insulating layer 407a is formed, heat treatment (preferably at 200 to 400° C., for example, 250 to 350° C.) may be performed in an inert gas atmosphere or an oxygen gas atmosphere.

Further, oxygen doping treatment using oxygen plasma may be performed after the formation of the insulating layer 402a, after the formation of the oxide semiconductor film, after the formation of the conductive layer serving as a source electrode or a drain electrode, after the formation of the insulating layer, or after the heat treatment. For example, oxygen doping treatment using a high-density plasma of 2.45 GHz may be performed. Alternatively, oxygen doping treatment may be performed by an ion implantation method or ion doping. By the oxygen doping treatment, variations in electrical characteristics of the transistors can be reduced. For example, the oxygen doping treatment is performed to cause the insulating layer 402a or the insulating layer 407a, or both to contain oxygen with a higher proportion than that in the stoichiometric composition. Consequently, excessive oxygen in the insulating layer is likely to be supplied to the oxide semiconductor layer 403a. This can reduce oxygen deficiency defects in the oxide semiconductor layer 403a or at the interface between one or each of the insulating layer 402a and the insulating layer 407a and the oxide semiconductor layer 403a, thereby reducing the carrier concentration of the oxide semiconductor layer 403a.

For example, when an insulating layer containing gallium oxide is formed as one or each of the insulating layer 402a and the insulating layer 407a, the composition of the gallium oxide can be set to be Ga₂Oₓ by supplying the insulating layer with oxygen.

Alternatively, when an insulating layer containing aluminum oxide is formed as one or each of the insulating layer 402a and the insulating layer 407a, the composition of the aluminum oxide can be set to be Al₂Oₓ by supplying the insulating layer with oxygen.

Alternatively, when an insulating layer containing gallium aluminum oxide or aluminum gallium oxide is formed as one or each of the insulating layer 402a and the insulating layer 407a, the composition of the gallium aluminum oxide or the aluminum gallium oxide can be set to be GaₓAl₂₋ₓO_{3+α} by supplying the insulating layer with oxygen.

Through the steps, an impurity such as hydrogen, moisture, a hydroxyl group, or hydride (also referred to as a hydrogen compound) is removed from the oxide semiconductor layer 403a and oxygen is supplied to the oxide semiconductor layer 403a. Thus, the oxide semiconductor layer can be highly purified.

Note that although the example of the method for forming the transistor illustrated in FIG. 6A is described, this embodiment is not limited to this example. For the description of the components in FIGS. 6B to 6E, for example, see as appropriate the description of the example of the method for forming the transistor illustrated in FIG. 6A if the components in FIGS. 6B to 6E have the same designations as the components in FIG. 6A and have a function at least part of which is the same as that of the components in FIG. 6A.

As described with reference to FIGS. 6A to 6E and FIGS. 7A to 7E, the example of the transistor in this embodiment includes a conductive layer functioning as a gate electrode; an insulating layer functioning as a gate insulating layer; an oxide semiconductor layer which includes a channel and overlaps with conductive layer functioning as a gate with the insulating layer functioning as a gate insulating layer interposed therebetween; a conductive layer which is electrically connected to the oxide semiconductor layer and functions as one of a source and a drain; and a conductive layer which is electrically connected to the oxide semiconductor layer and functions as the other of the source and the drain.

In an example of the transistor of this embodiment, an insulating layer in contact with an oxide semiconductor layer is in contact with an insulating layer serving as a gate insulating layer in a portion without the oxide semiconductor layer, a conductive layer serving as one of a source and a drain, and a conductive layer serving as the other of the source and the drain. Consequently, the oxide semiconductor layer, the conductive layer serving as one of a source and a drain, and the conductive layer serving as the other of the source and the drain are surrounded by the insulating layer in contact with an oxide semiconductor layer and the insulating layer serving as a gate insulating layer, thereby reducing the entry of an impurity into the oxide semiconductor layer, the conductive layer serving as one of a source and a drain, and the conductive layer serving as the other of the source and the drain.

The oxide semiconductor layer in which a channel is formed is an oxide semiconductor layer which is made intrinsic (i-type) or substantially intrinsic (i-type) by the purifying operation. Purifying the oxide semiconductor layer can lower the carrier concentration in the oxide semiconductor layer to less than 1×10¹⁴/cm³, preferably less than 1×10¹²/cm³, more preferably less than 1×10¹¹/cm³, thereby reducing changes in characteristics due to temperature change. Further, with the above structure, off-state current per micrometer of channel width can be 10 aA (1×10⁻¹⁷ A) or less, 1 aA (1×10⁻¹⁸ A) or less, 10 zA (1×10⁻²⁰ A) or less, 1 zA (1×10⁻²¹ A) or less, or 100 yA (1×10⁻²² A) or less. It is preferable that the off-state current of the transistor be as low as possible. The lower limit of the off-state current of the transistor in this embodiment is estimated to be about 10⁻³¹ A/μm.

The transistor including an oxide semiconductor layer in this embodiment is used for one or more of transistors in the display circuit, the display selection signal output circuit, the display data signal output circuit, the photodetector circuit, the photodetection reset signal output circuit, and the output selection signal output circuit of the input-output device in the above embodiment; therefore, the reliability of the input-output device can be improved.

### Embodiment 7

In this embodiment, described are examples of an electronic appliance each provided with the input-output device of the above embodiments.

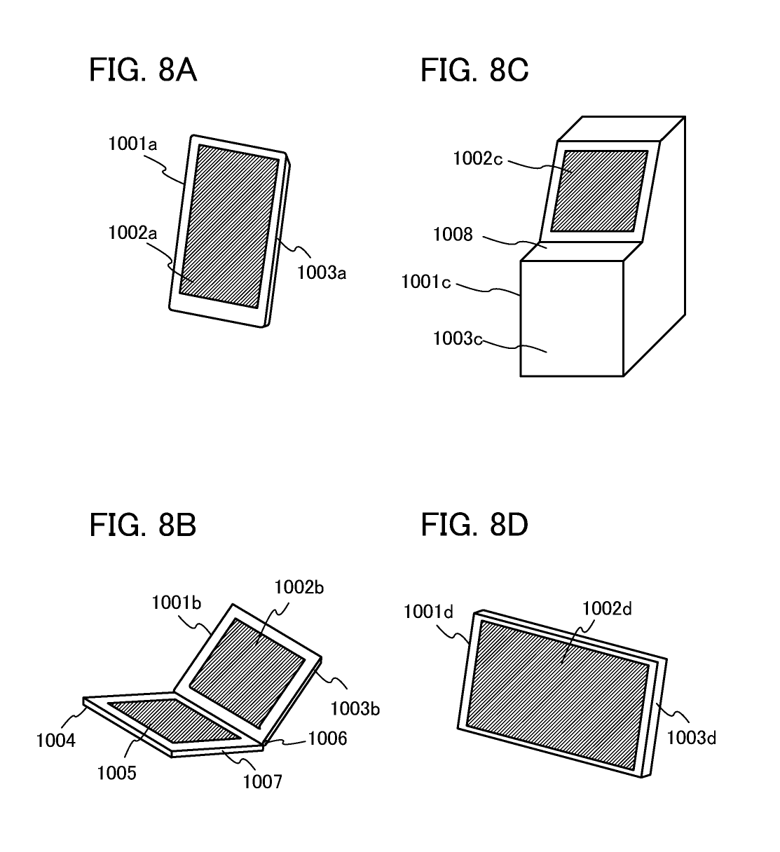

Structural examples of the electronic appliances of this embodiment will be described with reference to FIGS. 8A to 8D. FIGS. 8A to 8D are schematic views each illustrating a structural example of the electronic appliance of this embodiment.

An electronic appliance in FIG. 8A is an example of a mobile information terminal. The mobile information terminal in FIG. 8A includes a housing 1001a and a display portion 1002a provided in the housing 1001a.

Note that a side surface 1003a of the housing 1001a may be provided with a connection terminal for connecting the mobile information terminal to an external device and one or more buttons used to operate the mobile information terminal in FIG. 8A.

The mobile information terminal in FIG. 8A includes a CPU, a memory circuit and an image processing circuit, an interface transmitting/receiving a signal traveling between the external device and each of the CPU and the memory circuit and the image processing circuit, and an antenna transmitting/receiving a signal to/from the external device, in the housing 1001a. Note that one or more integrated circuit(s) with a specific function may be provided in the housing 1001a.

The mobile information terminal in FIG. 8A serves, for example, as one or more devices selected from a telephone, an electronic book, a personal computer, and a game machine.

An electronic appliance in FIG. 8B is an example of a folding mobile information terminal. The mobile information terminal in FIG. 8B includes a housing 1001b, a display portion 1002b provided in the housing 1001b, a housing 1004, a display portion 1005 provided in the housing 1004, and a hinge 1006 for connecting the housing 1001b and the housing 1004.

In the mobile information terminal in FIG. 8B, the housing 1001b can be stacked on the housing 1004 by moving the housing 1001b or the housing 1004 with the hinge 1006.

Note that a side surface 1003b of the housing 1001b or a side surface 1007 of the housing 1004 may be provided with a connection terminal for connecting the mobile information terminal to an external device and one or more buttons used to operate the mobile information terminal in FIG. 8B.

The display portion 1002b and the display portion 1005 may display different images or continuous images. Note that the display portion 1005 is not necessarily provided; a keyboard which is an input device may be provided instead of the display portion 1005.

The mobile information terminal in FIG. 8B includes a CPU, a memory circuit, an image processing circuit, and an interface transmitting/receiving a signal traveling between the external device and each of the CPU and the memory circuit and the image processing circuit, in the housing 1001b or the housing 1004. Note that one or more integrated circuit(s) with a specific function may be provided in the housing 1001b or the housing 1004. In addition, the mobile information terminal in FIG. 8B may include an antenna transmitting/receiving a signal to/from the external device.

The mobile information terminal in FIG. 8B serves, for example, as one or more devices selected from a telephone, an electronic book, a personal computer, and a game machine.

The electronic appliance in FIG. 8C is an example of a stationary information terminal. The stationary information terminal in FIG. 8C includes a housing 1001c and a display portion 1002c provided in the housing 1001c.

Note that the display portion 1002c can be provided in a top board 1008 of the housing 1001c.

The stationary information terminal in FIG. 8C includes a CPU, a memory circuit, an image processing circuit, and an interface transmitting/receiving a signal traveling between the external device and each of the CPU and the memory circuit and the image processing circuit, in the housing 1001c. Note that one or more integrated circuit(s) with a specific function may be provided in the housing 1001c. In addition, the stationary information terminal in FIG. 8C may include an antenna transmitting/receiving a signal to/from the external device.

Further, a side surface 1003c of the housing 1001c in the stationary information terminal in FIG. 8C may be provided with one or more parts selected from a ticket ejection portion that ejects a ticket or the like, a coin slot, and a bill slot.

The stationary information terminal in FIG. 8C serves, for examples, as an automated teller machine, a information communication terminal for ticketing or the like (also referred to as a multi-media station), or a game machine.

FIG. 8D shows an example of a stationary information terminal. The stationary information terminal in FIG. 8D includes a housing 1001d and a display portion 1002d provided in the housing 1001d. Note that a support for supporting the housing 1001d may also be provided.

Note that a side surface 1003d of the housing 1001d may be provided with a connection terminal for connecting the mobile information terminal to an external device and one or more buttons used to operate the mobile information terminal in FIG. 8D.

In addition, the mobile information terminal in FIG. 8D may include a CPU, a memory circuit, an image processing circuit, and an interface transmitting/receiving a signal traveling between the external device and each of the CPU and the memory circuit and the image processing circuit, in the housing 1001d. Note that one or more integrated circuit(s) with a specific function may be provided in the housing 1001d. In addition, the mobile information terminal in FIG. 8D may include an antenna transmitting/receiving a signal to/from the external device.

The stationary information terminal in FIG. 8D serves, for example, as a digital photo frame, an input-output monitor, or a television device.

The input-output portion of the input-output device of the above embodiments is used, for example, as a display portion of an electronic appliance. The input-output device of the above embodiments is used, for example, as each of the display portions 1002a to 1002d in FIGS. 8A to 8D. In addition, the input-output device of the above embodiments may be used as the display portion 1005 in FIG. 8B.

As described with reference to FIGS. 8A to 8D, examples of an electronic appliance of this embodiment each include a display portion for which the input-output device of the above embodiments is used. Consequently, it is possible to operate the electronic appliance or input a datum to the electronic appliance with a finger or a pen. Further, a process can be selected and performed in accordance with an area of the region of the pixel portion with which an object to be read overlaps.

In addition, the housings of the examples of electronic appliances of this embodiment may be each provided with a photoelectric transducer generating power source voltage in accordance with the intensity of incident light and/or an operating unit for operating the input-output device. Providing a photoelectric transducer, for example, eliminates necessity of an external power source, allowing the above electronic appliance to be used for a long period of time even in a place without an external power source.

This application is based on Japanese Patent Application serial no. 2010-183759 filed with Japan Patent Office on Aug. 19, 2010, the entire contents of which are hereby incorporated by reference.

What is claimed is:

1. An input-output device comprising:
an input-output portion including a pixel portion including;
a display circuit to which a display selection signal is input, to which a display data signal is input in accordance with the display selection signal, and which become a display state in accordance with the display data signal; and
a photodetector circuit which generates an optical datum corresponding to an illuminance of incident light, and
a data processing portion including,
an image processing circuit including a labeling processing circuit in which a label is imprinted on the optical datum with a value larger than a reference datum, a count circuit which counts a number of optical data on each of which the label of the same group is imprinted, and a comparator which compares a count value of the optical data on each of which the label of the same group is imprinted and both a first reference count value and a second reference count value;
a memory circuit in which the optical data are sequentially stored and a plurality of programs are stored; and
a CPU which controls whether one or more of the plurality of programs is performed in accordance with a result of the comparator.

2. The input-output device according to the claim 1, wherein the input-output portion includes a field-effect transistor.

3. The input-output device according to the claim 1, wherein the input-output device is provided in one selected from the group consisting of a mobile information terminal, a folding mobile information terminal, and a stationary information terminal.

4. A driving method of an input-output device comprising:
an input-output portion which includes a pixel portion including;
a display circuit to which a display selection signal is input, to which a display data signal is input in accordance with the display selection signal, and which become a display state in accordance with the display data signal; and
a photodetector circuit which generates an optical datum corresponding to an illuminance of incident light, and
a data processing portion including an image processing circuit, a memory circuit in which a plurality of programs are stored, and a CPU,
the driving method comprising steps of:
storing optical data in the memory circuit sequentially;
reading the optical data sequentially from the memory circuit by the image processing circuit;
imprinting a label on the optical datum with a value larger than a reference datum; and
counting a number of optical data on each of which the label of the same group is imprinted,
wherein in a case of a count value of the optical data each on each of which the label of the same group is imprinted is larger than or equal to a first reference count value and smaller than or equal to a second reference count value, a coordinate of a center of a region in the pixel portion, provided with the photodetector circuit in which the optical data on each of which the label of the same group is imprinted is generated, is calculated by the image processing circuit; the coordinate of the center is output to the CPU; and one or more of the plurality of programs are read from the memory circuit and are performed by the CPU in accordance with the coordinate of the center, and
wherein in a case of the count value of the optical data on each of which the label of the same group is imprinted is larger than the second reference count value, in the region of the pixel portion, provided with the photodetector circuit in which the optical data on each of which the label of the same group is imprinted, one or more of the plurality of programs are read from the memory circuit and are performed by the CPU.

5. The driving method of the input-output device according to claim 4, wherein in the case where the count value of the optical data on each of which the label of the same group is imprinted is larger than the second reference count value, an image signal is generated using the optical data on each of which the label of the same group is imprinted, the display data signal is generated based on the image signal, and the display data signal which is generated is sequentially output to the display circuit.

6. The driving method of the input-output device according to claim 4, wherein the input-output portion includes a field-effect transistor.

7. The driving method of the input-output device according to claim 4, wherein the input-output device is provided in one selected from the group consisting of a mobile information terminal, a folding mobile information terminal, and a stationary information terminal.
